(19) United States
(12) Patent Application Publication
(10) Pub. No.: US 2006/0096934 A1
(43) Pub. Date: May 11, 2006

(54) Oil filter assembly

(76) Inventors: Keith R. Weinberger, Randolph, NJ (US); Alan Johnson, Attelboro, MA (US); James Pereira, Rehoboth, MA (US); Joseph Borgia, Cranston, RI (US); Mario A. Turchi, Tenafly, NJ (US); Robert Joachim, Glen Rock, NJ (US); Adrian Jefferies, Thatcham (GB); James Gladding, Caine (GB); Kevin Smith, Dunmow (GB); Chris Ryall, Kenilworth (GB); Kent Nicholson, NewtonWisbech (GB)

Correspondence Address: MCANDREWS HELD & MALLOY, LTD, 500 WEST MADISON STREET, SUITE 3400, CHICAGO, IL, 60661, US

(21) Appl. No.: 11/033,566

(22) Filed: Jan. 11, 2005

Related U.S. Application Data
(60) Provisional application No. 60/625,522, filed on Nov. 5, 2004.

(51) Int. Cl. B01D 35/00

(52) U.S. Cl. 210/791; 210/171; 210/232

(57) ABSTRACT

An oil filter system includes an oil filter module and an adapter. The oil filter module includes a detent and an actuator. The adapter includes a protuberance and is configured to be secured to the engine. The oil filter module connects to the adapter when the detent secures to the protuberance as the oil filter module is urged into a connection position with the adapter. The oil filter module disconnects from the adapter when the actuator is actuated, thereby disengaging the detent from the protuberance.

### RELATED APPLICATIONS

This application relates to and claims priority benefits of U.S. Provisional Application No. 60/625,522, entitled “Oil Filter Assembly,” which was filed Nov. 5, 2004, which is hereby incorporated by reference in its entirety.

### BACKGROUND OF THE INVENTION

Embodiments of the present invention generally relate to an oil filter assembly, and more particularly to an oil filter assembly that is configured to be quickly and easily changed.

A conventional oil filter assembly for an internal combustion engine typically includes a threaded end, which is rotated, twisted, or spun, onto a corresponding mounting structure of the engine. Once the assembly is mounted onto the engine, oil is circulated through the engine for filtering. Unfiltered oil from the engine is passed through a filtering media, such as a pleated paper cylinder, of the assembly. As the unfiltered oil passes through the filtering media, impurities contained within the oil are retained by the filter. Filtered oil is then passed back into the engine. Eventually, an oil filter assembly, or at least the filtering media within the assembly, needs to be replaced due to the fact that it becomes clogged with numerous impurities, thereby diminishing its filtering ability.

Typical filters may be one-, two-, or three-part filters, depending on whether the parts of the filter can be disconnected from one another. In a one-part filter assembly, the filtration media is contained within a housing, and the entire filter assembly is screwed onto and off of an engine. When the filter medium is clogged, the entire filter assembly must be replaced.

A typical two-part filter assembly includes a casing and a base that threadably engage one another to form a housing around the filtration media. The base is affixed to a mounting structure of an engine. For example, the base may be screwed onto a mounting stud of the engine. The casing, including the filtration media, may be removably secured, such as through threadable engagement, to the base, without removing the base from the engine. When the filtering media needs to be replaced, the casing is removed from the base, and a new casing is secured to the base.

A typical three-part filter assembly is similar to the two part filter assembly, except that the filtration media is separable from the rest of the assembly. As such, only the filtration media needs to be replaced, and the rest of the assembly may be reused with a new filtration medium.

In order to change the filtration media in typical filters, one component is typically unscrewed from another component. The threads of, and/or other components (such as gaskets) located proximate to, such threadable interfaces are prone to sticking, which can pose difficulties in removing an oil filter from the engine (for a one-part filter assembly), or the casing from the base (for a two- or three-part filter assembly). Often, a specialized tool, such as an oil filter wrench, is required to remove the filter or casing from the engine. In many vehicles, however, the oil filter assembly is located at a position that is difficult to access. Thus, using a tool with some oil filters may be difficult. Even if a tool were not required, manually unscrewing, or otherwise rotating the oil filter may also not be easy due to limited space proximate the engine and oil filter assembly.

Thus, a need exists for an oil filter assembly that is quick and easy to connect and disconnect from an engine. That is, a need exists for a system and method of quickly and efficiently changing an oil filter.

### SUMMARY OF THE INVENTION

Certain embodiments of the present invention provide a fluid filter system including a first segment having a ridge adapted to engage a detent, and a second segment that is configured to connect to the first segment. The second segment includes a medium for filtering the fluid, a detent engageable with the ridge to secure the first segment to the second segment, and an actuator. The detent is moveable between a locked position and an unlocked position, and is normally biased into the locked position. The actuator is configured to selectively urge the detent into the unlocked position, thereby releasing the second segment from the first segment.

The actuator is located on a user accessible side of the fluid filter system, such that a user can easily engage the actuator. The first segment is located on an engine side of said fluid filter system, such that it may be connected to an engine.

The second segment may be used as a tool to secure the first segment to an engine. The second segment and the first segment may be configured to rotate along with one another when the first segment is being secured to the engine (but before the first segment is completely secured to the engine). The first and second segments do not rotate along with one another when the first segment is secured to the engine. While the second segment may still rotate relative to the first segment, the first segment remains stationary after it is secured to the engine. Rotation of the second segment relative to said first segment produces a clicking sound, thereby alerting the user that the first segment is secured to the engine.

Certain embodiments of the present invention also provide an oil filter system configured to filter oil used within an engine. The system includes an oil filter module and an adapter or base.

The oil filter module includes at least one lock, clip, latch, or other such mechanism, and a plunger configured to be actuated toward the lock. The adapter is configured to be secured to the engine, and includes a protuberance, such as a spike, bar, tab, post, tube, or other such member extending outwardly therefrom. The oil filter module connects to the adapter when the lock secures (such as through a snapable engagement) to the spike as the oil filter module is urged into a connection position with the adapter. The oil filter module disconnects from, or is otherwise released from locking engagement with, the adapter when the plunger is actuated into the lock, thereby disengaging the lock from the spike.

A resilient ring is positioned around, and exerts a force into, the lock. The force exerted by the resilient ring serves to maintain the lock in operable alignment. A plunger engagement recess is defined by the lock. The plunger may be urged into the plunger engagement recess, thereby spreading, opening, or otherwise disengaging the lock. The lock disengages from the spike when the lock is spread open.

The oil filter module may also include a filter support having an end cap and a perforated tube, and a central tube disposed within said perforated tube. The central tube defines a plunger channel therein, and the plunger and the lock are disposed within the plunger channel. An oil outlet channel is defined between the perforated tube and the central tube, and a filter medium is disposed around the perforated tube and supported by the end cap. The system may also include a filter enclosure disposed over the filter medium. Additionally, a housing is disposed over the filter enclosure, and a portion of the adapter is compressively sandwiched between a portion of the housing and a portion of the filter enclosure when the filter module is connected to the adapter. A seal may be positioned between the portion of the filter enclosure and the portion of the adapter.

The adapter also includes an unfiltered oil inlet or opening and a filtered oil passage, and the filter module includes an unfiltered oil inlet passage in communication with the unfiltered oil opening and a filtered oil outlet channel in communication with the filtered oil passage when the filter module is connected to the adapter. An oil inlet valve may be disposed within the unfiltered oil inlet passage. The oil inlet valve opens when oil circulates through the oil filter system, and the oil inlet valve closes when the filter module is disconnected from the adapter. That is, the oil inlet valve functions as a result of fluid flow through the oil filter system. When the filter module is disconnected from the adapter, however, the oil inlet valve forms sealingly engages the oil inlet passage so that oil does not drain therefrom.

Additionally, an oil outlet valve may be disposed proximate an outlet of the filtered oil outlet channel. The oil outlet valve opens when oil circulates through the oil filter system, and closes when the filter module is disconnected from the adapter.

The system may also include a spring secured to the adapter. The spring abuts the filter module and exerts a force into the filter module when it is connected to the adapter. The spring acts to push the filter module away from the adapter when the lock disengages the spike. The spike includes a shaft having a notch formed therein, and a beveled tip. The notch is configured to snapably retain a portion of the lock.

Certain embodiments of the present invention also provide an oil filter adapter or base unit configured to be secured to a mounting structure of an engine. The adapter includes a main body having at least one oil inlet opening and at least one oil outlet opening formed through the main body. The oil inlet opening allows unfiltered oil to pass from the engine to the filter module, and the oil outlet opening allowing filtered oil to pass from the filter module to the engine. An insert securing member, which may include a spike, post, tube, or barb, outwardly extends from the main body. The insert securing member is configured to securely retain a portion of the filter module in order to connect the filter module to the adapter. The main body may also include at least one bypass opening configured to allow oil to pass therethrough when a differential oil across a bypass valve becomes too great. In other words, when pressure within the oil filter module reaches a certain level wherein a differential pressure across the bypass valve reaches a certain level, the bypass valve opens to relieve the pressure.

Certain embodiments of the present invention also provide a method of disconnecting an oil filter module from an oil filter adapter, wherein the oil filter module includes a locking mechanism secured to a securing member of the adapter. The method includes pushing a button disposed on the oil filter module, disengaging the locking mechanism from the securing mechanism through the pushing step, and disconnecting the oil filter module from the oil filter adapter through the disengaging step.

The pushing step may include pushing a button cover disposed over a plunger head, so that the button cover is actuated into the plunger head.

The disengaging step may also include spreading the locking mechanism open through the actuating step, such that the spreading step includes removing the locking mechanism from a retaining feature of the securing mechanism.

The disconnecting step may also include forcing the oil filter module away from the oil filter adapter through a spring. The disconnecting step does not include rotating the oil filter module relative to the oil filter adapter. Instead, it includes removing the oil filter module from the oil filter adapter in a linear, non-twisting direction.

Certain embodiments of the present invention also provide a fluid filter system including a filter module including a button and a latching tube having a retaining slot formed about an inner circumference, wherein a fluid passage is formed through a central portion of the latching tube.

An adapter has at least one retaining member, which may be a metal ball, cylinder, ridge, or other member positioned about an outer periphery of a sleeve having a fluid channel formed therethrough. The retaining slot is configured to receive and retain the retaining member.

The filter module connects to the adapter when the retaining slot receives and retains the retaining member as the filter module is urged into a connection position with the adapter. The filter module disconnects from the adapter when the button is pressed, thereby disengaging the retaining member from the retaining slot.

An actuator is operatively connected to the button and the latching tube. The actuator acts to urge the sleeve further into the adapter causing the retaining member to disengage from the retaining slot when the button is pressed.

The sleeve includes a first portion integrally formed with a second portion through a slanted ledge. The first portion has a smaller diameter than the second portion. The retaining member is compressively sandwiched between a collar member and the upper portion when the filter module is disconnected from the adapter. The latching tube urges the collar member into a position in which it disengages from the retaining member when the insert module is urged into the connection position. The latching tube engages the retaining member when the collar member disengages from the retaining member.

The sleeve may also include a central post that engages a reciprocal structure on the plug seal when the filter module is urged into the adapter. The central post exerts a force into the reciprocal structure thereby urging the plug seal into an open position such that fluid may pass through the fluid outlet of the filter module.

The system may also include a spring-biased plug seal that automatically plugs a fluid outlet of the filter module when the filter module is disconnected from the adapter.

Certain embodiments of the present invention also provide a fluid filter system configured to filter fluid of a device. The system includes a filter module including a main body having a bottom plate and an actuator, wherein a detent is formed in the bottom plate. The system also includes an adapter configured to be secured to the device. The adapter includes a main body with at least one spring-biased protuberance extending outwardly therefrom. The filter module connects to the adapter when the detent secures to the protuberance as the filter module is urged into a connection position with the adapter. The filter module disconnects from the adapter when the actuator is actuated, thereby disengaging the detent from the protuberance.

The detent may be a groove, notch, or channel formed on the bottom plate. The protuberance on the adapter may be a cylinder that extends from the main body at an angle.

The adapter may also include a spline extending from the main body. Further, the filter module may include a tab that is configured to align with the spline when the filter module is connected to the adapter. The system may be configured to be used as a tool to secure the adapter to the device, such that the adapter is securely fastened to the device when the tab is rotated into an engagement position with the tab, thereby precluding further rotation of the filter module and the adapter.

The actuator may include a button portion integrally connected to a top cap, wherein an axial cross-sectional area of the actuator is substantially equal to that of the oil filter module.

The system may also include a drip seal plug and an anti-spill valve. The anti-spill valve sealingly engages the drip seal plug when the filter module is disconnected from the adapter, and disengages from the drip seal plug when the filter module connects to the adapter.

### BRIEF DESCRIPTION OF SEVERAL VIEWS OF THE DRAWINGS

FIG. 1 illustrates an isometric exploded view of an oil filter assembly, according to an embodiment of the present invention.

FIG. 2 illustrates an isometric view of an oil filter assembly from a first perspective, according to an embodiment of the present invention.

FIG. 3 illustrates an isometric view of an oil filter assembly from a second perspective, according to an embodiment of the present invention.

FIG. 4 illustrates a transverse axial cross-sectional view of an oil filter assembly, according to an embodiment of the present invention.

FIG. 5 illustrates a partial cross-sectional view of an interface between a base of an adapter and a filter enclosure, according to an embodiment of the present invention.

FIG. 6 illustrates a partial isometric cross-sectional view of an oil filter assembly, according to an embodiment of the present invention

FIG. 7 illustrates a simplified isometric cross-sectional view of collars secured around a spike, according to an embodiment of the present invention.

FIG. 8 illustrates a simplified isometric view of collars secured around a spike, according to an embodiment of the present invention.

FIG. 9 illustrates a transverse cross-sectional view of an oil filter assembly, according to an alternative embodiment of the present invention.

FIG. 10 illustrates a transverse cross-sectional view of an oil filter assembly, according to another alternative embodiment of the present invention.

FIG. 11 illustrates a transverse cross-sectional view of an oil filter assembly, according to yet another alternative embodiment of the present invention.

FIG. 12 illustrates an adapter, according to an embodiment of the present invention.

FIG. 13 illustrates a transverse cross-sectional view of an oil filter assembly, according to still another alternative embodiment of the present invention.

FIG. 14 illustrates an isometric view of a disconnected oil filter assembly, according to an embodiment of the present invention.

FIG. 15 illustrates a cross-sectional view of an oil filter assembly in which a filter module is disconnected from an adapter.

FIG. 16 illustrates a cross-sectional view of an oil filter assembly in which a filter module is connected to an adapter.

FIG. 17 illustrates a cross-sectional view of an oil filter assembly according to an embodiment of the present invention.

FIG. 18 illustrates a front view of an adapter according to an embodiment of the present invention.

FIG. 19 illustrates a front view of an oil filter assembly according to an embodiment of the present invention.

FIG. 20 illustrates a partial internal view of an oil filter assembly with particular components hidden according to an embodiment of the present invention.

FIG. 21 illustrates a cross-sectional view of an oil filter assembly in which a filter module is disconnected from an adapter according to an embodiment of the present invention.

FIG. 22 illustrates a cross-sectional view of an oil filter assembly in which a filter module is connected to an adapter according to an embodiment of the present invention.

FIG. 23 illustrates a front view of an oil filter assembly secured to an engine, according to an embodiment of the present invention.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

### DETAILED DESCRIPTION OF THE INVENTION

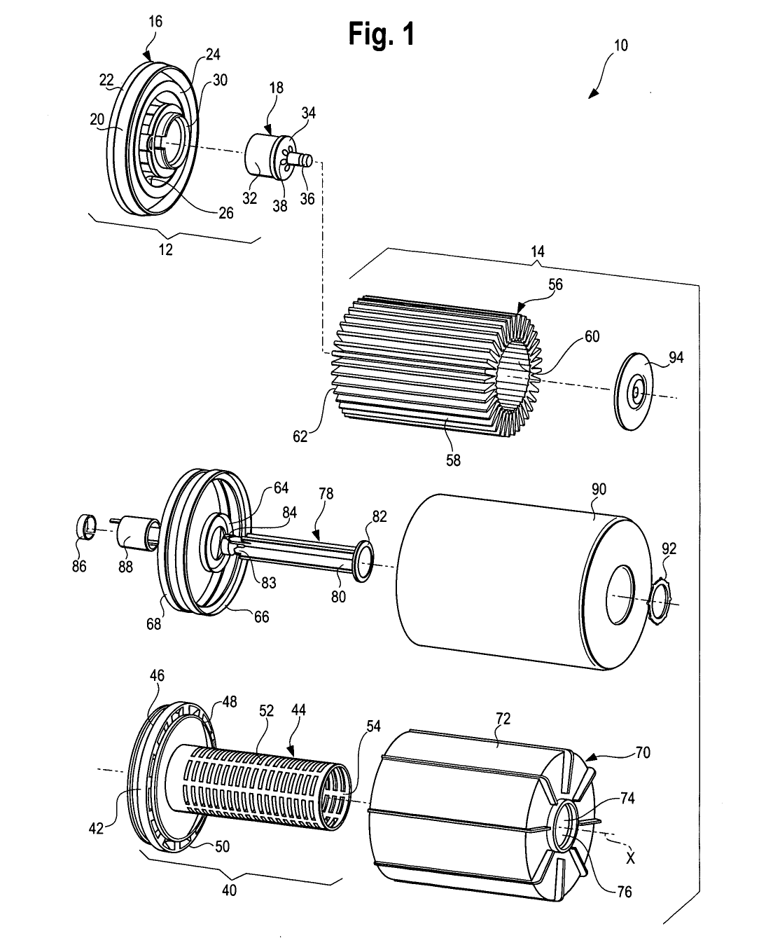

FIG. 1 illustrates an isometric exploded view of an oil filter assembly 10 according to an embodiment of the present invention. The oil filter assembly 10 includes a first segment, such as an adapter 12 and a second segment, such as a filter module 14, or insert. The adapter 12, which may be a metal, such as steel, an aluminum silicon alloy, or a nonmetallic material, includes a generally circular adapter base 16 and an insert securing member 18. The base 16 includes an outer wall 20 integrally formed with an engine engagement surface 22, and an insert engagement surface 24. A plurality of oil inlet openings 26 are formed between and through the engine engagement surface 22 and the insert engagement surface 24. The interior portion of the engine engagement surface 22 may be threaded and adapted to threadably engage a mounting structure (not shown) of an engine (not shown) in a conventional manner. Thus, the base 16 may be threadably secured, such as through rotating or screwing, to an engine. Optionally, the base 16 may be adapted to be bonded, welded, or otherwise secured to an engine. Alternatively, the base 16 may be integrally formed with the engine.

The base 16 includes a central passage 30 configured to receive and retain a plug 32 of the engagement member 18. That is, the plug 32 is snapably, threadably, or otherwise securely retained within the central passage 30 of the base 16. Alternatively, the engagement member 18 may be integrally formed with the base 16.

The plug 32 is a generally cylindrical structure that is integrally formed with an upper surface 34 having a spike, post, ridge, barb, protuberance, or other such outwardly extending member 36 extending therefrom. The upper surface 34 also includes a plurality of oil outlet passages 38 positioned radially around an axial cross-sectional envelope of the spike 36. The engagement member 18 is configured to allow oil to pass through the oil outlet passages 38, through the plug 32, and into the central passage 30. Oil may then pass from the central passage 30 into the engine. The insert engagement surface 24 is configured to mate with an adapter engagement end of the filter module 14.

The filter module 14 includes a filter support 40 having an end cap 42 integrally formed with a center tube 44. Optionally, the end cap 42 and the center tube 44 may be separate and distinct from one another. The end cap 42 includes a cylindrical wall 46 integrally formed with a filter support surface 48 having a plurality of oil inlet passages 50 formed proximate an exterior edge of the filter support surface 48. The oil inlet passages 50 are configured to align with the oil inlet openings 26 of the adapter 16. As such, oil may pass from an engine into the filter module 14 through the adapter 12.

The center tube 44 includes a plurality of openings 52 formed therethrough that allow oil to pass from the outside of the center tube 44 into an interior passage 54 within the center tube 44. When the filter module 14 is secured to the adapter 12, filtered oil passes through the interior passage 54 and through an oil outlet (not shown) of the filter support 40. The oil then passes through oil outlet passages 38 of the adapter and into the engine.

A filter medium 56 is positioned on the filter support 40. The filter medium 56 may be formed of paper, cellulose, fiberglass, polyester, or various other known filtering materials. The filter medium 56 may include a generally cylindrical pleated main body 58 having a channel 60 formed through a longitudinal axis. An end 62 of the filter medium 56 abuts the filter support surface 48 of the filter support 40 so that the oil inlet passages 50 are positioned around an outer perimeter of the filter medium 56. Also, the center tube 44 of the filter support 40 is positioned within the channel of the filter medium 56. As such, unfiltered oil that passes through the oil inlet passages 50 passes through the filter medium 56 and is thereby filtered of impurities. The filtered oil then passes through openings 52 of the center tube 44 and into interior passage 54, and eventually through an oil outlet (and subsequently through the oil outlet passages 38 of the adapter 12).

The insert securing member 18 is configured to mate into an oil outlet defined at an end of the interior passage 54 of the center tube 44. An oil outlet valve 64 is positioned proximate the area where the insert securing member 18 mates into the interior passage 54 in order to prevent oil leakage. Additionally, an oil inlet valve 66 is positioned proximate the oil inlet passages 50. An additional seal 68 may be positioned around the filter support 40 to provide additional protection against leakage. The valves 64, 66 and the seal 68 may be formed of rubber or various other suitable materials.

A filter enclosure 70 is positioned over the filter medium 56 and the filter support 40. The filter enclosure 70 includes a generally cylindrical main body 72 having a central tube 74 formed through a central axis x. The central tube 74 defines an actuator or plunger channel 76. An open end (not shown) of the main body 72 of the enclosure is secured around the cylindrical wall 46 of the end cap 42. For example, the main body 72 may snapably, threadably, or otherwise securely mate with the cylindrical wall 46.

Alternatively, instead of the filter enclosure 70, a central tube may extend from a base that may be positioned over the center tube 44 of the filter support 40. Thus, the filter medium 56 may not be enclosed on its sides by a wall. Instead, the filter medium 56 may be enclosed by a housing, such as housing 90 discussed below.

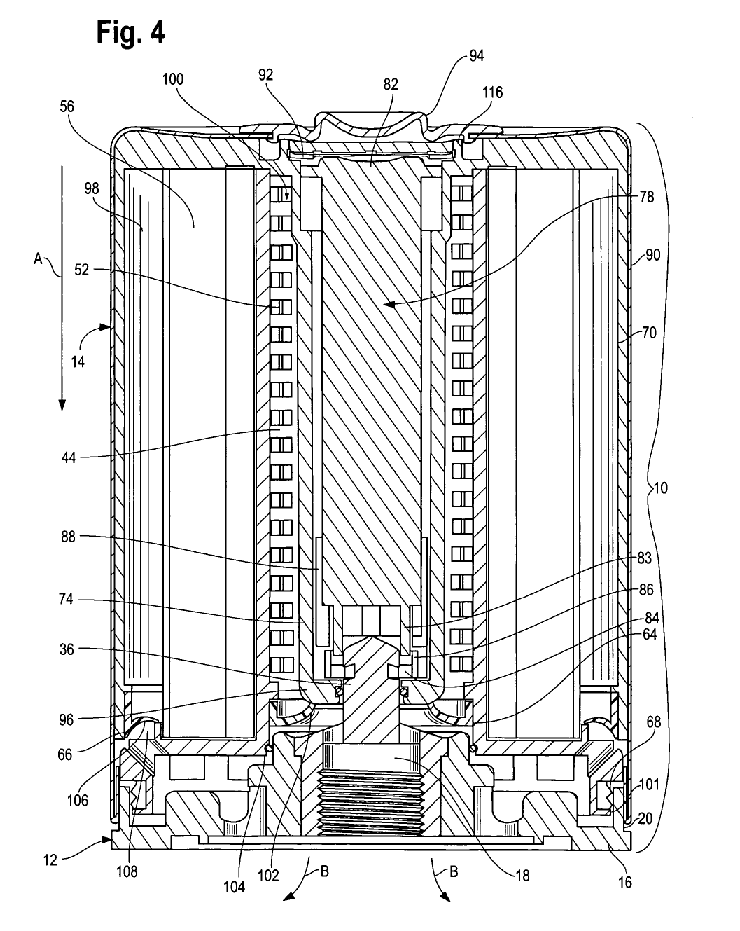

The diameter of the plunger channel 76 is smaller than the diameter of the center tube 44 of the filter support 40. As such, the central tube 74 is configured to be positioned within the interior passage 54 of the center tube 44. Oil passes through an outlet channel (shown in FIG. 4), which is defined within the interior passage 54 between the interior of the center tube 44 and the exterior of the central tube 74. As discussed below, structures within the central tube 74 are configured to securely fasten to the spike 36 of the adapter 12. The oil outlet valve 64 sealingly engages an area proximate the interface of the spike 36 and the central tube 74 so that oil does not infiltrate the plunger channel 76.

An actuator, such as a plunger 78, is positioned within the plunger channel 76. The plunger 78 includes a shaft 80 integrally formed with a head (or button) 82 at a first end and a lock engaging end 83 at a second end. The shaft 80 is configured to be slidably retained within the plunger channel 76 of the central tube 74.

A detent, such as a split collar assembly having two semi-circular clips, locks or collars 84, is positioned within the plunger channel 76 and abut the lock engaging end 82. A resilient securing ring 86 is positioned about the collars 84, thereby biasing the collar 84 into a closed or locked position. The resilient securing ring 86 may be a round spring or formed of rubber or any other material that is elastic and exerts an inwardly directed force when the collars 84 are urged open. Alternatively, a single lock member may be used instead of the two collars 84. For example, the single lock member may resemble the two collars 84 integrally connected to one another. The single lock member may include the collars 84 having resilient material integrally connecting the collars 84 together.

A guide sleeve 88 is positioned about the lock engaging end 83 within the plunger channel 76 and assists in ensuring that the plunger 78 is properly aligned with respect to the collars 84 and the insert securing member 18 of the adapter 12.

An outer housing 90 is positioned over the filter enclosure 70. A button cover securing ring 92 is positioned over a portion of an outer surface of the filter enclosure 70 around the plunger channel 76. The button cover securing ring 92 is configured to securely retain a resilient button cover 94 relative to the outer housing 90. Optionally, the outer housing 90 may be integrally formed with the button cover 94.

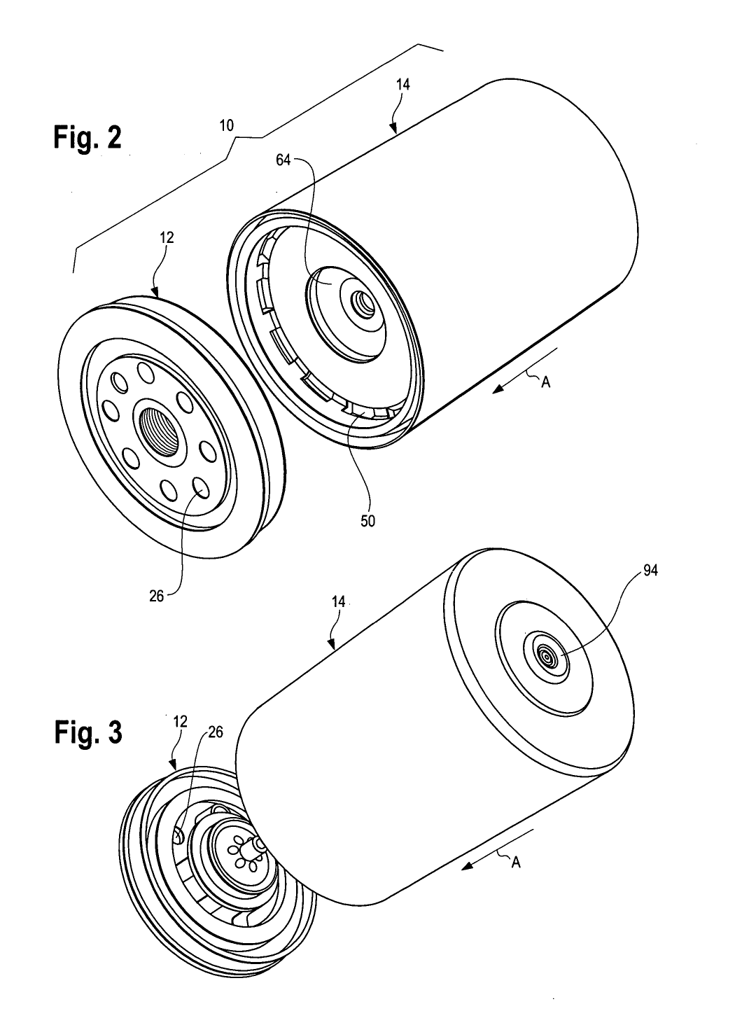

FIG. 2 illustrates an isometric view of the oil filter assembly 10 from a first perspective. As shown in FIG. 2, the adapter is configured to connect to an engine, while the filter module 14 is configured to be accessible to a user. In order to connect the filter module 14 to the adapter 12, the filter module 14 is pushed, pressed, or otherwise urged into the adapter 12 in the direction of arrow A. The filter module 14 need not be rotated, twisted, or turned in order to attain a secure connection. Instead, as discussed in greater detail below, the filter module 14 may simply be pushed or urged into the adapter 12 until a click is heard or felt, thereby signaling a secure connection (as discussed in greater detail below with respect to 7).

Once the filter module 14 is securely connected to the adapter, unfiltered oil may pass from the oil inlet openings 26 of the adapter 12 into the oil inlet passages 50 of the end cap 42. The unfiltered oil may then pass through the filter module 14 as discussed above in order to filter the unfiltered oil. The filtered oil exits the filter module 14 through an oil outlet (which is covered by the oil outlet valve 64 in FIG. 2). The filtered oil then passes into the engine through the central passage 30 of the adapter 12.

FIG. 3 illustrates an isometric view of the oil filter assembly 10 from a second perspective. As shown in FIG. 3, the button cover 94, and therefore the actuator or plunger 78 (not shown in FIG. 3) is configured to be on a user accessible side of the filter assembly 10, as opposed to the adapter 12, which is on the engine side of the filter assembly 10. In order to disconnect the filter module 14 from the adapter 12, the button cover 94 is pressed in the direction of arrow A. As discussed below, the button cover 94 is urged into the head 82 (shown in FIG. 1) of the plunger 78 (shown in FIG. 1), which acts to release the insert 14 from the adapter 12. The button cover 94 protects the button (the head 82 shown in FIG. 1) from unintended pressure. For example, an automobile utilizing the oil filter assembly 10 may encounter rocks or other debris agitated by the motion of the automobile itself, or other vehicles. The button cover 94 protects the button from being hit by such debris. The button cover 94 may be a convex shape in which the middle portion is sunken in relation to the edges of the button cover. The convex shape of the button cover 94 protects against accidental pressing of the button cover 94 by outside forces. That is, the chance of accidental pressing of the button cover 94 from inadvertent outside forces (such as a rock) is decreased due to the fact that the middle portion of the button cover 94 is sunken toward the interior of the filter assembly 10.

FIG. 4 illustrates a transverse cross-sectional view of the oil filter assembly 10. As shown in FIG. 4, the filter module 14 is connected to the adapter 12. Oil passes from an unfiltered oil cavity 98 through the filter medium 56. The filtered oil passes through the openings 52 in the center tube 44 into a filtered oil outlet channel 100, which is defined between an interior of the center tube 44 and an exterior of the central tube 74. The filtered oil then is passed through the oil inlet openings 26 (shown in FIGS. 1 and 3) of the insert securing member 18, and ultimately into the central passage 30 of the adapter 12.

The oil outlet valve 64 provides a seal between the end cap 52 and a distal end 96 of the central tube 74. As oil passes from the oil outlet channel 100 into the central passage 30 of the adapter, the pressure of the circulating oil causes an unsecured interior flap 102 of the oil outlet valve 64 to move in the direction of arrows B. As such, the oil outlet valve 64 flaps open, thereby allowing the filtered oil to pass into the oil outlet passages 38 of the insert securing member 18. At the same time, the oil outlet valve 64 restricts oil flow to and from a bypass channel 104. When oil is not circulating through the filter assembly 10, the oil outlet valve 64 restricts oil flow out of the filter module 14. In general, the pressure from the weight of the oil itself, as opposed to the pressure of circulating oil, is insufficient to force the unsecured interior flap 102 open. As such, the oil outlet valve 64 ensures that oil within the oil outlet channel 100 remains within the filter module 14 when the filter module 14 is removed from the adapter 12. Also, the oil outlet valve 64 does not permit oil to flow back into the oil outlet channel 100 once oil passes out of the filter module 14.

Similar to the oil outlet valve 64, the oil inlet valve 66 restricts flow out of the filter module 14. The oil inlet valve 66 is disposed within an unfiltered oil path of the filter module 14. The oil inlet valve 66 is secured to an interior wall of the filter enclosure 70 and includes an unsecured flap 106 that is in a sealing engagement with the end cap 42. When there is no oil circulation within the oil filter assembly 10, the oil inlet valve 66 provides a seal between the filter enclosure 70 and the end cap 42, thereby blocking oil from entering the oil cavity 98 through an unfiltered oil inlet 108. The pressure of circulating oil, however forces the flap 106 into an open position, thereby allowing oil to pass from the unfiltered oil inlet 108 into the oil cavity 98. The oil inlet valve 66 ensures that oil does not drip out of the oil cavity 98 when the filter module 14 is removed from the adapter 12.

As mentioned above with respect to FIG. 2, in order to connect the filter module 14 to the adapter 12, the filter module 14 is urged toward the adapter in a linear direction shown by arrow A. The filter module 14 need not be twisted, screwed, or otherwise rotated. Instead, the filter module 14 is simply urged into the adapter 12 in the direction of arrow A.

In order to connect the filter module 14 to the adapter 12, the filter module 14 is urged into a final connection position in the direction of arrow A. Once the filter module 14 reaches a final connection position, the collars 84 located within a distal end 96 of the central tube 74 snapably engage the spike 36 of the adapter 12, thereby generating a “clicking” sound (as discussed in more detail below with respect to 7). The collars 84 are secured to an interior portion of the distal end 96 of the central tube 74 and snapably engage the spike 36. Optionally, the collars 84 may be integrally formed with the central tube 74.

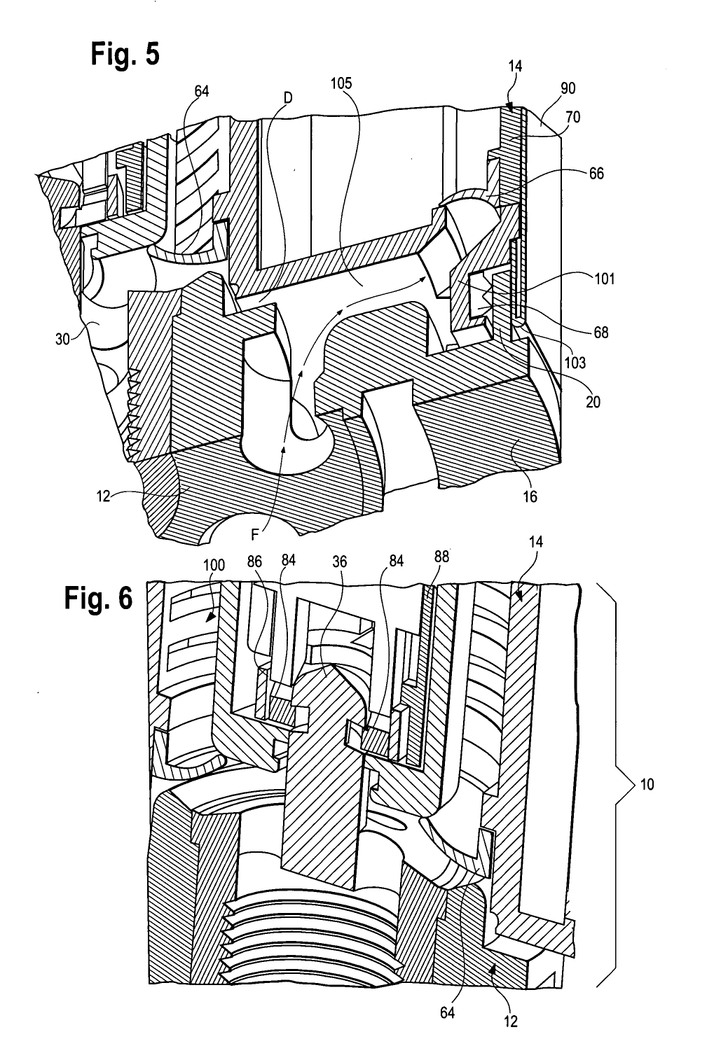

FIG. 5 illustrates a partial cross-sectional view of the interface between the base 16 and the filter enclosure 70. When the filter module 14 is in the final connection position, the outer wall 20 of the base 16 of the adapter 12 is compressively sandwiched between an end wall portion 101 of the filter enclosure 70 and an end wall portion 103 of the outer housing 90. The seal 68 is disposed between the outer wall 20 of the base 16 and the end wall portion 101 of the filter enclosure 70. As such, a fluid tight seal is formed between these components.

In general, unfiltered oil enters the adapter 12 through the oil inlet openings 26 in the direction of arrow F. The unfiltered oil then passes through a fluid path 105 and through the oil inlet valve 66. Filtered oil passes through the oil outlet valve 64 and into the central passage 30 of the adapter 12 through the oil outlet passages 38 (shown, e.g., in FIGS. 1 and 3) formed in the insert securing member 18 (shown, e.g., in FIGS. 1 and 3).

Optionally, a bypass valve may be disposed within the fluid path 105 at a point where the unfiltered oil may commingle with the filtered oil, for example, at point D. The bypass valve may be configured to be operable at a wide range of set pressures. When the flow of oil through the oil filter assembly 10 is constricted or blocked, pressure builds within the oil filter assembly 10. In this situation, the bypass valve opens thereby returning unfiltered oil to the engine in order to ensure that an adequate supply of oil is supplied to the engine at all times.

Referring again to FIG. 4, the ring 86, which may be a spring or formed of rubber, exerts an inwardly directed force on the collars 84, thereby ensuring that the collars 84 remain secured to the spike 36. The distal end 96 of the central tube 74 may also include a gasket or other seal member that is configured to provide a seal around the spike 36 to ensure that oil does not flow into the plunger channel 76. Further, the ring 86 and the guide sleeve 88 may also provide a sealing barrier between the plunger channel 76 and the oil flow path.

In order to disconnect the filter module 14 from the adapter 12, the button cover 94 is pressed in the direction of arrow A. The button cover 94 may be formed of a resilient material, such as rubber, and securely fastens around barbs, tabs, posts, anchors, or other such securing members 116 of the filter enclosure 70 and/or the button cover securing ring 92. The button cover securing ring 92 also limits how far the button cover 94 may be pushed in the direction of arrow A.

As the button cover 94 is pressed in the direction of arrow A, an interior portion of the button cover 94 is urged into the head 82 of the plunger 78. The force exerted into the head 82 causes it, and therefore the rest of the plunger 78, to move in the direction of arrow A toward the spike 36.

FIG. 6 illustrates a partial cross-sectional view of the oil filter assembly 10. As shown in FIG. 6, the ring 86 is disposed around the collars 84, which are snapably secured to the spike 36. The plunger channel 76 is devoid of oil. That is, oil flows through the oil outlet channel 100, but is blocked from entering the plunger channel 76.

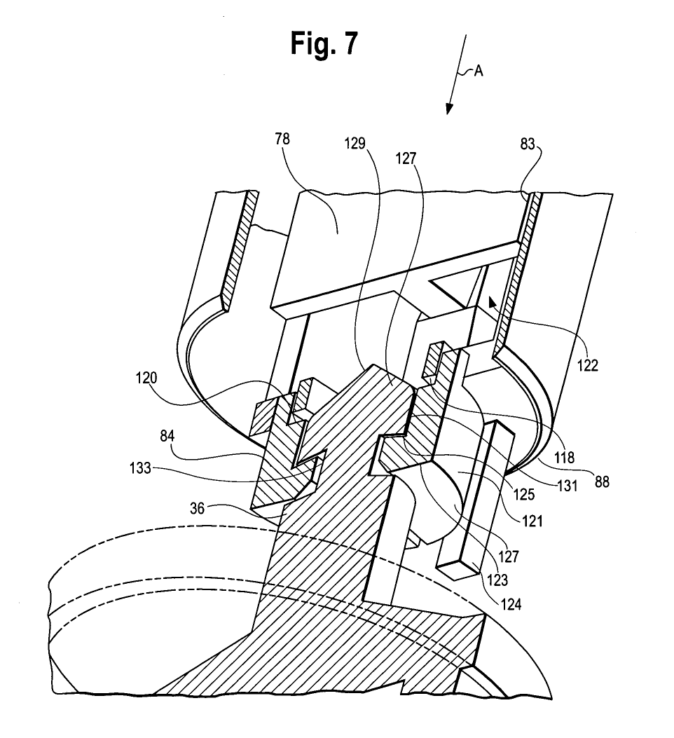

FIG. 7 illustrates a simplified isometric cross-sectional view of the collars 84 secured around the spike 36. The collars 84 are secured in position by the guide sleeve 88. The guide sleeve 88 includes tabs 118 that cooperate with reciprocal slots 120 of the collars 84 to ensure that the collars 84 are properly positioned. Further, the guide sleeve 88 includes an interior compartment 122, which receives and slidably retains the lock engaging end 83 of the plunger 78, in order to ensure that the plunger 78 is properly aligned with the collars 84 in the plunger channel 76. The guide sleeve 88 also includes an outwardly extending post 124 that is configured to mate with a reciprocal component, such as a slot, recess, cavity or divot, formed in the distal end 96 (shown in FIG. 4) of the central tube 74 (shown in FIG. 4). The post 124 may assist in properly aligning the guide sleeve 88 within the plunger channel 76.

The collars 84 include upright lateral walls 121 integrally formed with a horizontal beam 123, thereby defining a ledge 125. As the collars 84 are urged toward the spike 36, bottom surfaces 127 of the collars 84 encounter a beveled tip 127 of the spike 36. The beveled tip 127 includes ramped surfaces 129. As the bottom surfaces 127 continue moving over the ramped surfaces 129 in the direction of arrow A, the ramped surfaces 129 force the collars 84 to spread open. The ring 86 (shown, e.g., in FIG. 6) exerts an inwardly directed force on the collars 84. Upon increased movement in the direction of arrow A, the beams 123 slide over sides 131 of the spike 36 until they encounter channels 133 of the spike 36. Once the beams 123 encounter the channels 133, the inwardly-directed force exerted on the collars 84 by the ring 86 forces the lower beams 123 to snap into the notched portions 133, thereby producing a clicking sound and securing the lower beams 123 within the channels 133. As such, the collars 84 snapably engage the spike 36, and the filter module 14 is snapably secured to the adapter 12.

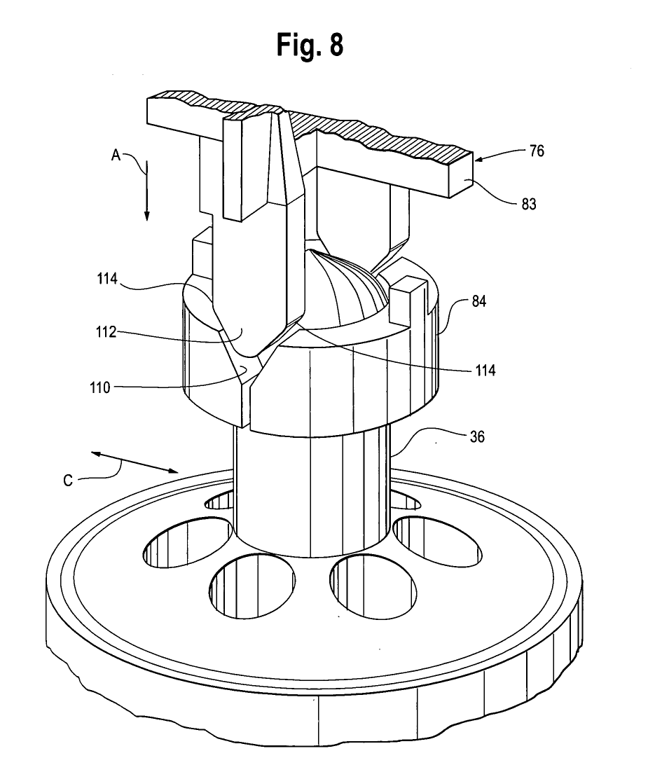

FIG. 8 illustrates a simplified isometric view of the collars 84 secured around the spike 36. For the sake of clarity, various components of the oil filter assembly 10 are not shown in FIG. 8. For example, the ring 86 is not shown, but it is noted that the ring 86 is positioned around the collars 84.

The collars 84 are, in the illustrated embodiment, semi-circular and together surround, and snapably engage, the spike 36, as discussed above. It is to be understood that the ring 86 (not shown in FIG. 8) surrounds the collars 84 and exerts an inwardly-directed force on the collars 84, thereby maintaining a secure connection between the collars 84 and the spike 36. Plunger engagement recesses 110 are defined between the inclined edges 111 of the collars 84 and are configured to allow passage of outwardly extending tabs 112 of the lock engaging end 83 of the plunger 78. As the plunger 78 is pushed toward the spike 36 in the direction of arrow A, the tabs 112 move into the recesses 110. The tapered recesses 110 are not large enough to accommodate the tabs 112. As such, when the tabs 112 move into the recesses, the outer walls 114 of the tabs 112 are forced into the inclined edges 111 of the collars 84, thereby spreading the collars 84 apart from one another in the directions denoted by arrow C. As the collars 84 spread apart, the locks lose engagement with the spike 36. Referring to FIG. 7, as the collars 84 spread apart, the lower beams 123 are removed from the channels 133. As such, the filter module 14 (shown in FIGS. 1-4) may be removed from the adapter 12 (also shown in FIGS. 1-4) by pushing the head 82 of the plunger 78. Additionally, a spring (not shown) may be disposed between the adapter 12 and the filter module 14 to provide additional force to assist in disconnecting the filter module 14 from the adapter 12 when the plunger 78 is engaged.

Referring to FIGS. 4, and 6-8, as the filter module 14 is removed from the adapter 12, the lock engaging end 83 of the plunger 78 is removed from the plunger engagement recesses 110. As the tabs 112 recede from the recesses 110, the inwardly directed force exerted by the ring 86 on the locks causes the collars 84 to move back together.

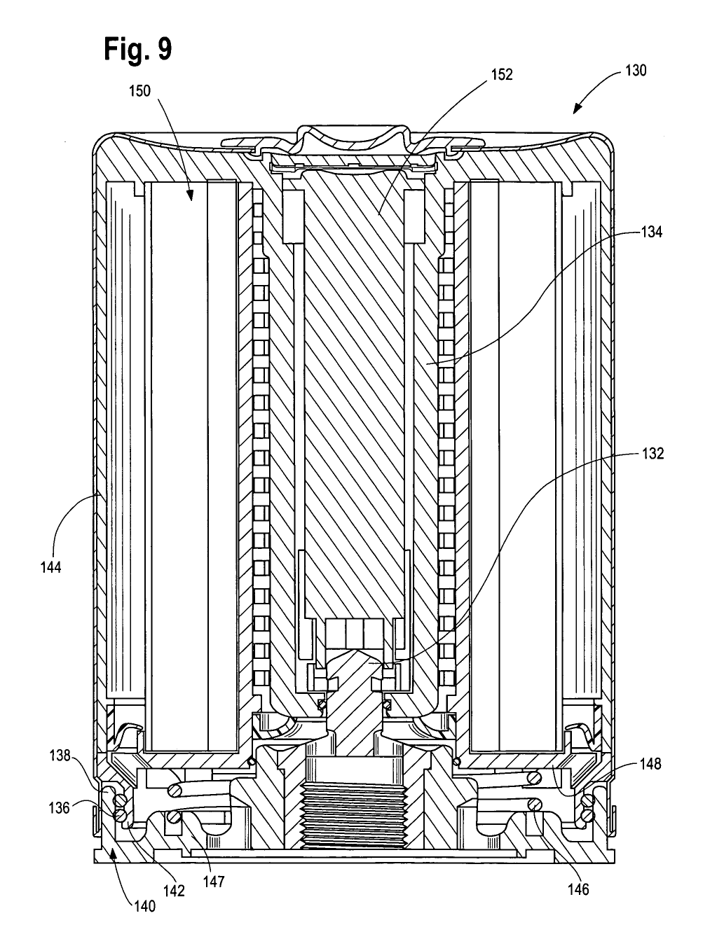

FIG. 9 illustrates a transverse cross-sectional view of an oil filter assembly 130, according to an alternative embodiment of the present invention. The assembly 130 differs from the assembly 10 shown in FIGS. 1-8 in that the assembly 130 includes a more robust spike 132, and a central tube 134 having a thicker wall. Also, a double ringed seal 136 is sandwiched between the outer wall 138 of the adapter 140 and the wall portion 142 of the filter enclosure 144. Further, a spring 146 is secured within a grooved interior wall 147 of the adapter 140 and exerts a force into the end cap 148 of the filter module 150. Thus, when the plunger 152 is actuated to disconnect the insert 150 from the adapter 140, the spring 146 urges the insert 150 away from the adapter 140.

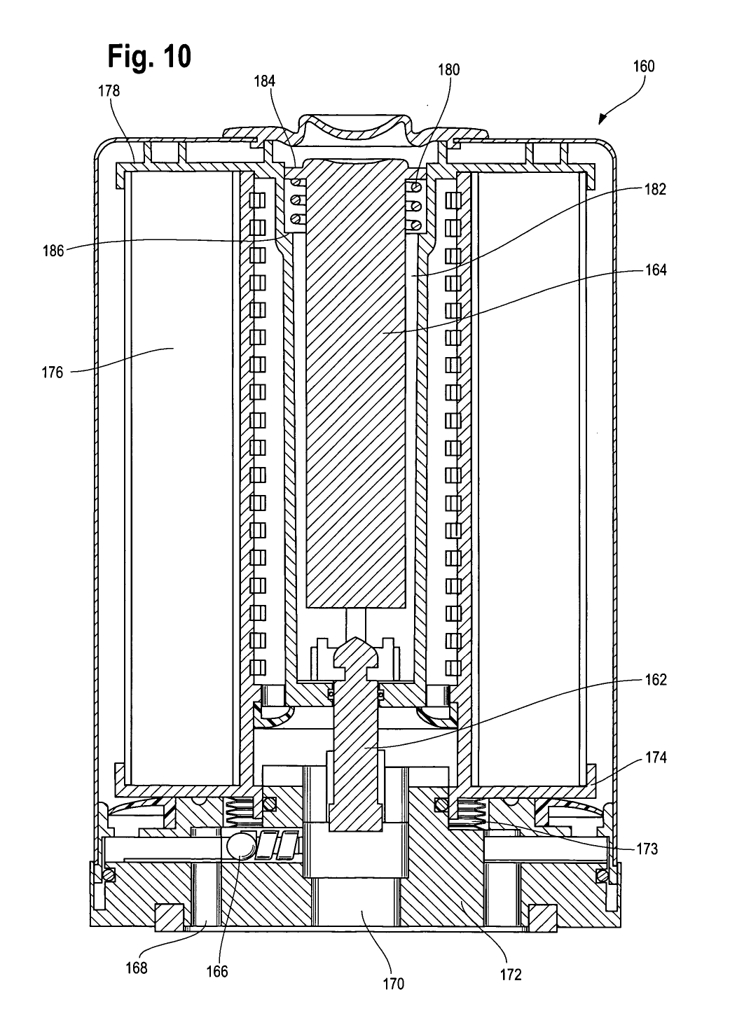

FIG. 10 illustrates a transverse cross-sectional view of an oil filter assembly 160, according to another alternative embodiment of the present invention. The oil filter assembly 160 includes a spike 162, which is longer than the spike 36 of the assembly 10, and a plunger 164, which is shorter than the plunger 78. Additionally, the assembly 160 includes a bypass valve 166 between an oil inlet 168 and an oil outlet 170. A spring member 173 is disposed between the adapter 172 and a bottom surface of the end cap 174. The assembly 160 does not include a filter enclosure. Instead, the filter medium 176 is disposed between a the first end cap 174 and the second end cap 178. Additionally, a spring 180 is disposed within the plunger channel 182 between a bottom surface of the plunger head 184 and a ledge 186. The spring 180 exerts a force into the plunger head 184 and acts to push the plunger head 184 away from the spike 162 after the plunger 164 is urged toward the adapter 172.

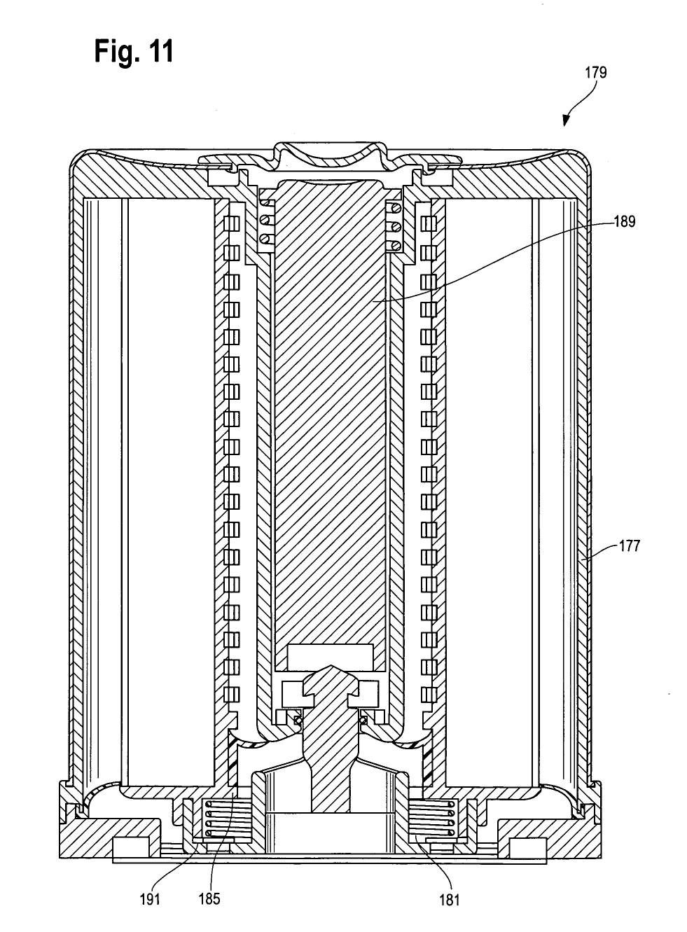

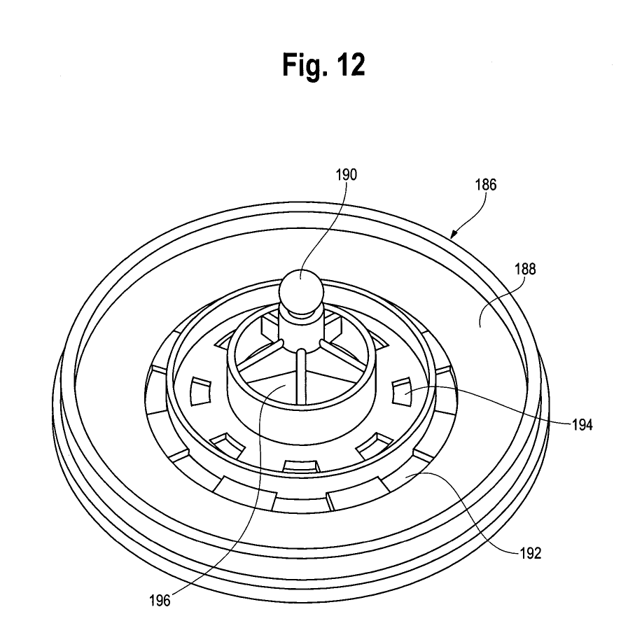

FIG. 11 illustrates a transverse cross-sectional view of an oil filter assembly 179, according to yet another alternative embodiment of the present invention. The assembly 179 includes a filter enclosure 177 and a relatively long plunger 189. A spring member 181 is disposed between the adapter 191 and the end cap 185.

FIG. 12 illustrates an adapter 186, according to an embodiment of the present invention. The adapter 186 includes a main body 188 and a spike 190. The main body 188 includes a first set of circumferentially spaced oil inlet openings 192, a second set of circumferentially spaced oil bypass openings 194, and a third set of circumferentially spaced oil outlet openings 196. The oil inlet openings 192 allow unfiltered oil to pass from an engine into the adapter 186. The oil bypass openings 194 are configured to allow oil to bypass a filter module when the pressure within the filter exceeds a certain point. The oil outlet openings 196 allow filtered oil to pass from a filter module, through the adapter 186, and into an engine.

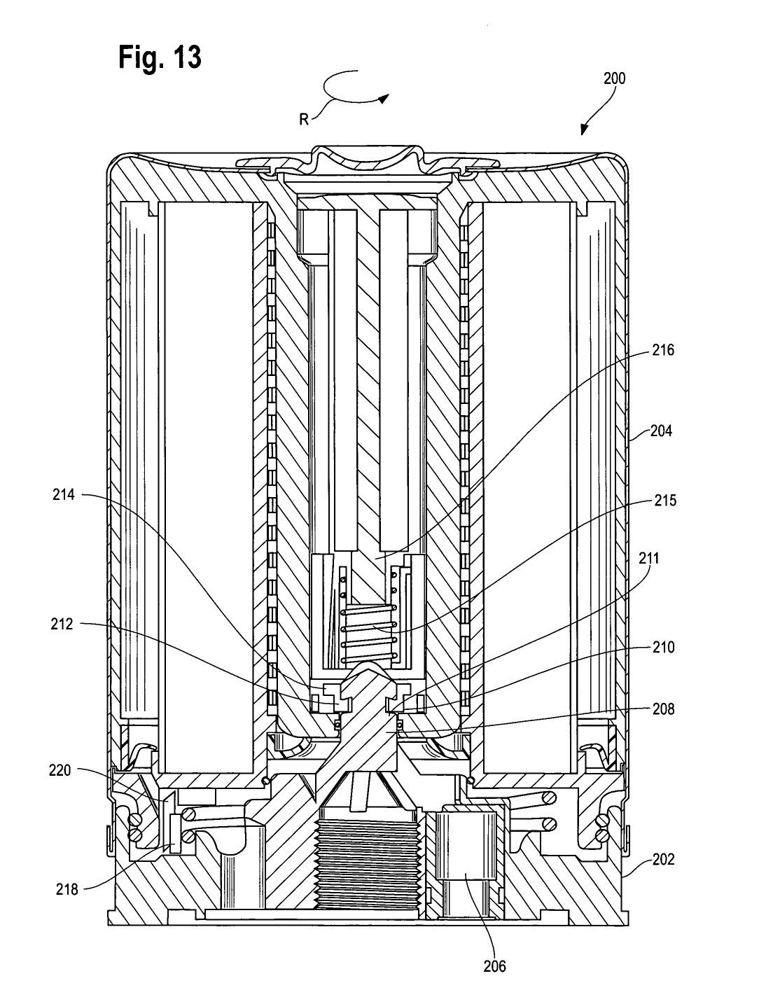

FIG. 13 illustrates a transverse cross-sectional view of an oil filter assembly 200, according to still another alternative embodiment of the present invention. The oil filter assembly 200 includes an adapter 202 removably secured to an oil filter module 204, similar to those described above. A bypass valve 206 is disposed within the adapter 202. The bypass valve 206 may be integrally formed with the adapter 202, or it may be separately inserted into a bypass valve channel within the adapter 202.

Additionally, the adapter 202 includes an integrally formed protuberance 208 (as opposed to the separate plug shown in FIG. 1) that is configured to be securely engaged by a locking detent member 210. As shown in FIG. 13, the locking detent member 210 includes a lower ledge 212 configured to abut against an engaging horizontal surface 211 of the protuberance 208 and an upper ledge 214 that extends away from the protuberance 208.

Additionally, a spring 215 is disposed between the protuberance 208 and the actuator 216. The spring 215 acts to keep the actuator 216 away from the protuberance 208. The spring 215 also acts to push the actuator 216 back to an unengaged position after the actuator 216 has been pressed to unlock the locking detent member 210.

The filter module 204 may be used as a tool to affix the adapter 202 to an engine. As mentioned above, the adapter 202 may be screwed onto a mounting stud of an engine. Before installing the adapter 202 onto the engine, the filter module 204 may be pushed, or otherwise urged (as discussed above) onto the adapter 202. Once secured to the adapter 202, the filter module 204 is configured to rotate along with the adapter 202 when the adapter 202 is being affixed to the mounting stud of the engine. When the adapter 202 is secured to the engine (i.e., when it is securely screwed onto the mounting stud), the adapter 202 ceases to be able to be rotated or screwed any further, while the filter module 204 may continue to be rotated. The adapter 202 may include structures allow a user to know that the adapter 202 is secured to the engine, as discussed below.

The adapter 202 includes an upwardly extending piece 218, which may be a post, wall or other such structure. The piece 218 is biased against a downwardly extending member 220, which may also be a post, wall, or other such structure, of the filter module 204. When the filter module 204 and the adapter 202 rotate together, the piece 218 and the member 220 remain in the same positions. That is, the member 220 does not rotate relative to the piece 218. However, when the adapter 202 is secured to an engine such that it cannot be rotated any further, the adapter 202 will remain stationary, while the filter module 204 may continue to be rotated. As the filter module 204 continues to be rotated, the member 220, which extends from the filter module 204, rotates relative to the piece 218 in the direction of R. Each time the member 220 contacts the piece 218 and rotates past it, a clicking sound will be produced, due to the member 220 engaging the piece 218. The clicking sound signals to a user that the adapter 202 is secured to the engine. As such, a user may affix the adapter 202 to the engine without the use of additional tools. Further, the user may install the adapter 202 in such a manner from an easily accessible location, instead of reaching up through areas where space may be limited.

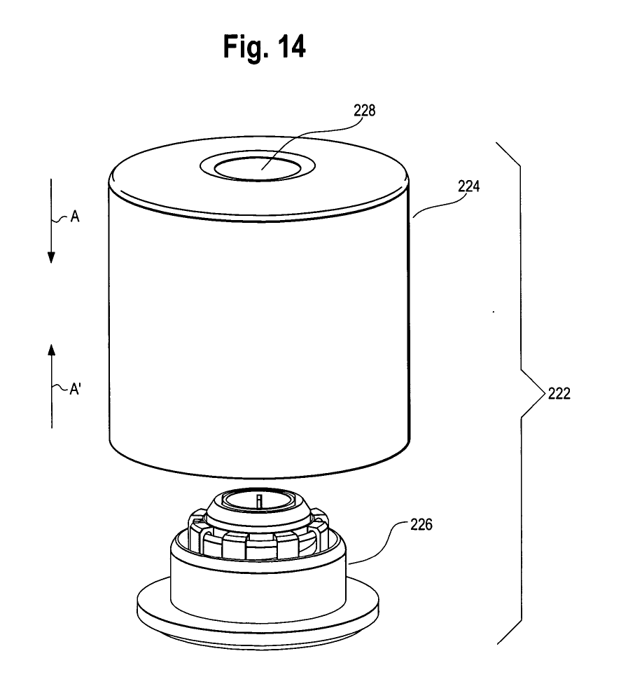

FIG. 14 illustrates an isometric view of a disconnected oil filter assembly 222, according to an embodiment of the present invention. The oil filter assembly 222 includes a filter module 224 that is configured to be removably secured to a connector, or adapter 226. The adapter 226 is configured to be threadbly, snapably, latchably, or otherwise secured to a mounting stud of an engine block.

Similar to the embodiments discussed above, in order to connect the module 224 to the adapter 226, the module 224 is urged into the adapter 226 in the direction of arrow A. The module 224 may snapably engage the adapter 226 in order to indicate that the module 224 is secured to the adapter 226. In order to remove the module 224 from the adapter 226, a button 228 on the module 224 is pressed in the direction of arrow A. As the button 228 is pressed, the module 224 disengages from the adapter 226 and is removed from the adapter 226 in the direction of arrow A′. Similar to the embodiments discussed above, the module 224 is secured to, and removed from, the adapter 226 in a linear fashion, but is not rotated or twisted when it engages and disengages the adapter 226.

Once the filter module 224 is securely connected to the adapter 226, unfiltered oil from an engine may pass from oil inlet openings formed through the adapter 226 into oil inlet passages of the filter module 224. The unfiltered oil then passes through a filter chamber of the filter module 224, wherein the unfiltered oil is passed through a filtering medium, which filters impurities from the oil. The filtered oil passes through an oil outlet of the filter module 224 into the adapter 226. The filtered oil then passes through the adapter 226 back into the engine.

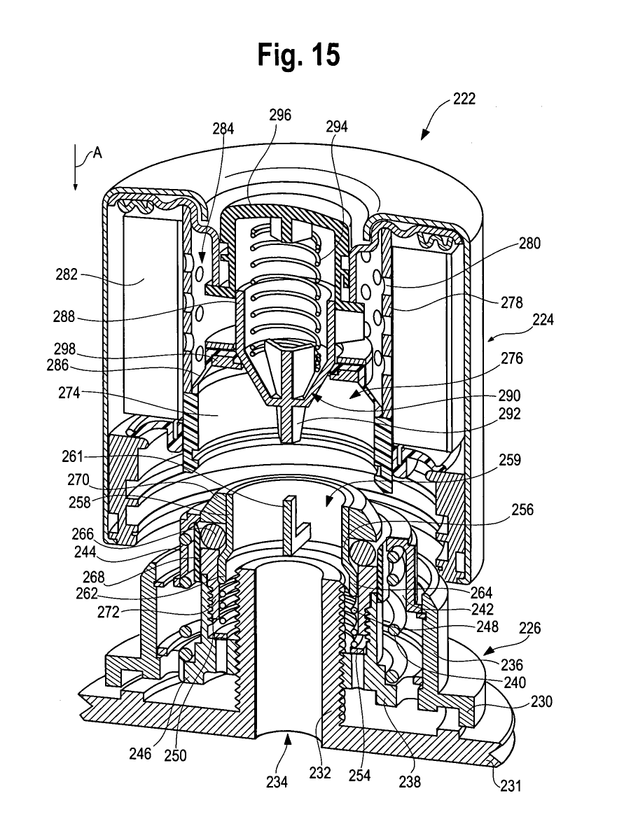

FIG. 15 illustrates a cross-sectional view of the oil filter assembly 222 in which the filter module 224 is disconnected from the adapter 226. The adapter 226 includes a base 230 that is configured to secure to a mounting stud 231 of an engine. A center tube 232 extends outwardly from a central portion of the base 230 and/or adapter 230 and includes a fluid passage 234. The base 230 supports an outer wall 236 and an inner wall 238 that may be integrally formed with the base 230. A spring 240 is disposed within a sealed cavity 242 that is positioned between the outer and inner walls 236 and 238. The spring 240 is vertically positioned between a cap 244 and a base portion 246 of the inner wall 238.

A spring 248 is also positioned between an interior portion 250 of the inner wall 238 and an outer wall 252 of the center tube 232. The spring 248 is biased against an inner base portion 254 of the inner wall 238 and sleeve 256. The sleeve 256 includes a tubular main body 258 having an upper portion 260 integrally formed with a lower portion 262 such a fluid outlet channel 259 is defined therethrough. A central post 261 extends inwardly from an inner wall of the sleeve 256. The diameter of the upper portion 260 is less than the diameter of the lower portion 262. The upper portion 260 is connected to the lower portion 262 through a slanted ledge 264.

Retaining members 266 are positioned between the sleeve 256 and an inner collar 268 that abuts the cap 244. The spring 248 is positioned between the inner collar 268 and the cap 244. The retaining members 266 may be metal, rubber or plastic balls. Optionally, a ring of material may be used instead of a plurality of retaining members.

A plurality of retaining members 266 are positioned around the sleeve 256. As shown in FIG. 15, when the module 224 is disconnected from the adapter 226, the retaining members 266 are positioned proximate the slanted ledge 264 above the lower portion 262. The retaining members 266 are compressively sandwiched between the inner collar 268 and the sleeve 256. While the spring 248 exerts a force into the sleeve 256 urging it upward, the sleeve 256 is held in place because the clearance area between the lower portion 262 and the inner collar 268 is smaller than the retaining members 266. As such, upward movement of the lower portion 262, and therefore the sleeve 256, is stopped by the retaining members 266. Rings 270 and 272 are positioned above and below the retaining members 266.

The module 224 includes a latch tube 274 having a fluid passage 276 defined therethrough. The latch tube 274 is positioned below the center tube 278, which includes fluid openings 280. The fluid openings 280 allow fluid that has been filtered through the media 282 to pass into a fluid channel 284. The filtered fluid passes through the fluid channel 284 into the fluid passage 276 through a check valve 286, similar to the embodiments discussed above.

A spring biased plug seal 288 extends into the fluid passage 276. The plug seal 288 includes a beveled tip 290 having an engagement post 292 extending outwardly therefrom. A spring 294 is positioned within the plug seal 288 and is biased into an actuator 296. The spring 294 exerts a force into the plug seal 288 in the direction of arrow A so that the beveled tip 290 is pushed into the fluid passage 276, while a seal member 298 sealingly engages around the plug seal 288. As such, fluid does not escape from the interior of the module 224 when it is disconnected from the adapter 226.

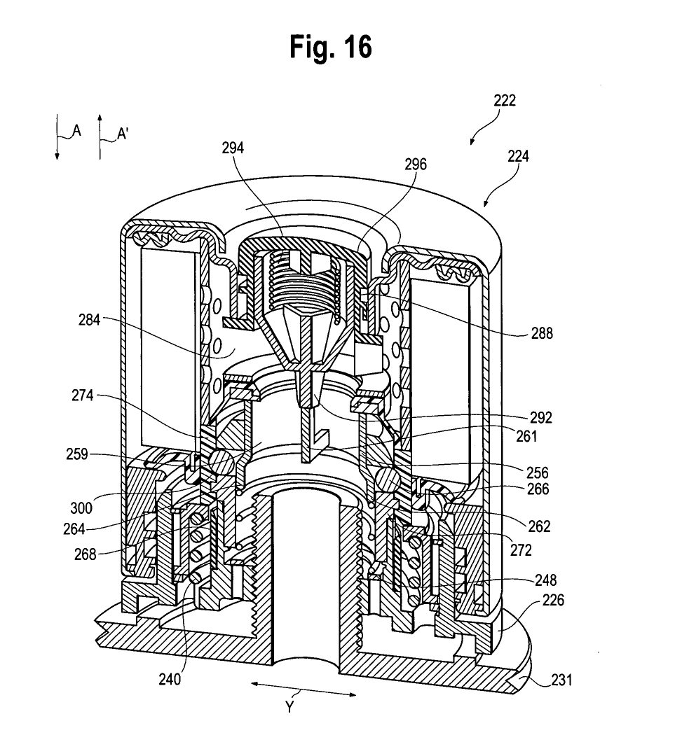

FIG. 16 illustrates a cross-sectional view of the oil filter assembly 222 in which the module 224 is connected to the adapter 226. As discussed above, in order to connect the module 224 to the adapter 226, the module 224 is urged into the adapter 226 in the direction of arrow A.

As the module 224 is urged into the adapter 226 in the direction of arrow A, the engagement post 292 of the plug seal 288 abuts the post 261 of the sleeve 256. As the module 224 continues to be urged into the adapter 226, the post 261 exerts a force in the direction of arrow A′, thereby pushing the plug seal into the actuator 296, and compressing the spring 294. In doing so, the seal member 298 loses sealing engagement with the plug seal 288, and an opening is formed between the fluid channel 284 and the fluid outlet channel 259 of the sleeve 256, so that fluid may pass therethrough.

Simultaneously, the latch tube 274 is urged in the direction of arrow A and abuts the collar 268. The latch tube 274 pushes the collar 268 down in the direction of arrow A, thereby compressing the spring 248. As the collar 268 moves down in the direction of arrow A, it loses contact with the retaining members 266. As such, the collar 268 no longer compressively sandwiches the retaining members 266 into the sleeve 256.

Once the collar 268 loses contact with the retaining members 266, the sleeve 256 is pushed upward in the direction of arrow A′ by way of the spring 248. As the sleeve 256 is moved in the direction of arrow A′, the slanted ledge 264 is also moved in the same direction. Continued movement of the sleeve 256 in the direction of arrow A causes the sleeve 256 to move past the retaining members 266 in the direction of arrow A′, and thereby causes the retaining members 266 to spread out in the direction of arrow Y. The latch tube 274 limits the movement of the retaining members 266 in the direction of arrow Y.

As the module 224 continues to be urged into the adapter in the direction of arrow A, the sleeve 256 continues to move toward the plug seal 288 in the direction of arrow A′. Conversely, the latch tube 274 continues to move toward the mounting stud 231 in the direction of arrow A. The latch tube 274 has at least one retaining slot 300 formed near a distal end. The retaining slot 300 is configured to receive and retain a retaining member 266. The latch tube 274 continues to move in the direction of arrow A until the retaining slots 300 encounter the retaining members 266. The retaining slots 300 secureably retain the retaining members 266. That is, the retaining members 266 are compressively sandwiched between the retaining slots 300, which conform to at least a portion of the contour of the retaining members 266, and the lower portion 262 of the sleeve 256. As such, the module 224 is secured to the adapter 226.

In order to disengage the module 224 from the adapter 225, the button 228 is pressed in the direction of arrow A. The button 228 then engages the actuator 296, which pushes the plug seal 288 into the sleeve 256. The sleeve 256 moves in the direction of arrow A, thereby compressing the spring 248. As the sleeve 256 moves in the direction of arrow A, the slanted edges 264 encounter the retaining members 266. As the retaining members 266 slide over the slanted edges 264, the retaining members 266 move inwardly toward the sleeve 256. Once the retaining members 266 move inwardly toward the sleeve 256, the retaining members 266 disengage from the retaining slots 300. Consequently, the force exerted by the spring 240 in the direction of arrow A′ forces the latch tube 274 in the direction of A′.

The movement of the latch tube 274 in the direction of arrow A′ forces the module 224 away from the adapter 226. As the module 224 disengages the adapter 226, the engagement post 292 of the plug seal 288 also disengages the post 261. The spring 294 then forces the plug seal 288 in the direction of arrow A until the plug seal sealingly engages the seal member 298, as discussed above.

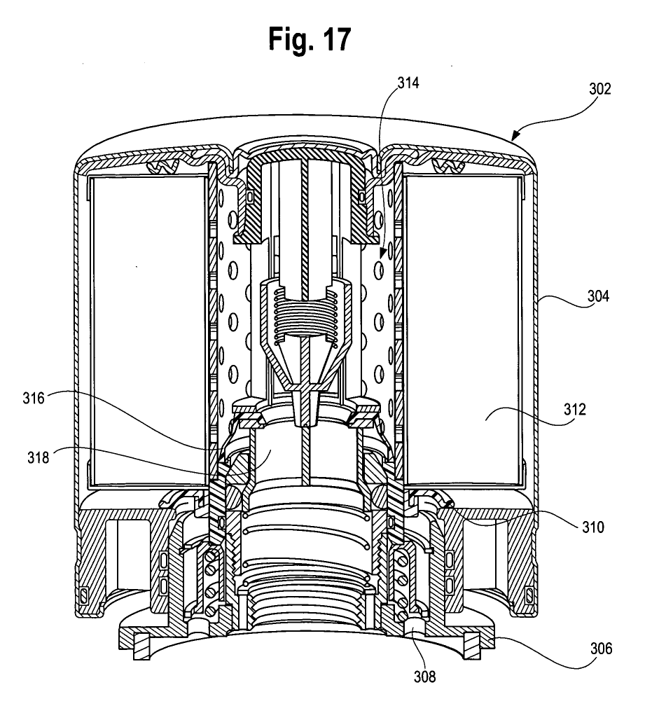

FIG. 17 illustrates a cross-sectional view of an oil filter assembly 302 according to an embodiment of the present invention. The oil filter assembly 302 is similar to the oil filter assembly 222 discussed above. The assembly 302 includes a module 304 that is removably secured to an adapter 306. Unfiltered fluid enters the assembly 302 through an inlet 308. The unfiltered fluid then passes through a check valve 310 into a filtering media 312. Unfiltered fluid is precluded from entering a filtered fluid passage 314 by way of a seal member 316. The unfiltered fluid is filtered by the filtering media 312. The filtered fluid then passes into the filtered fluid passage 314 of the module 304. The filtered fluid then passes through a filtered fluid channel 318, which is in fluid communication with the filtered fluid passage 314. The filtered fluid is then passed back into an engine.

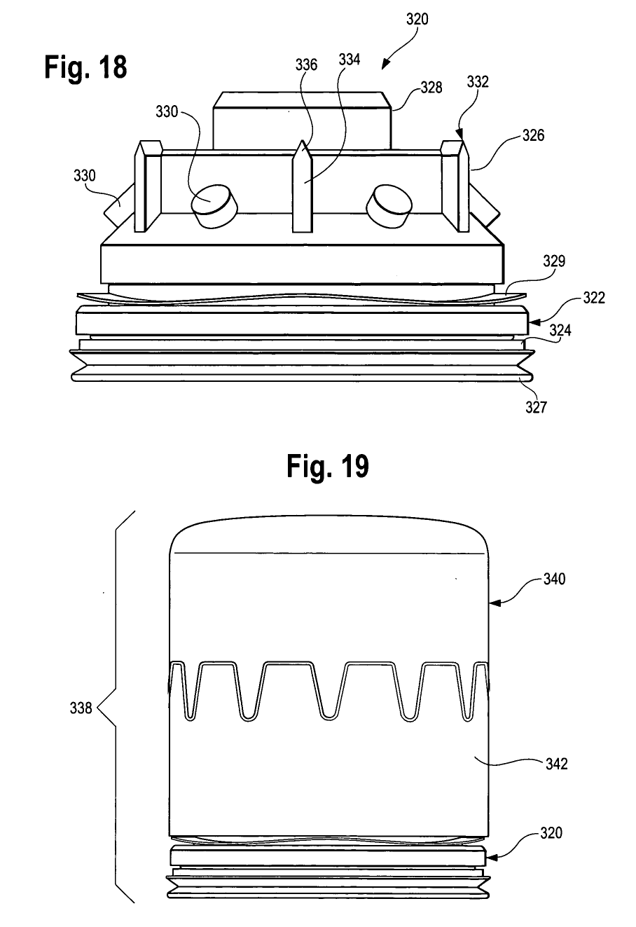

FIG. 18 illustrates a front view of an adapter 320 according to an embodiment of the present invention. The adapter 320 includes a main body 322 secured to a base 324 configured to be secured to a mounting stud of an engine. The base 324 may be connect to, or integrally formed, with an intermediate portion 326, which is in turn integrally formed with a center tube 328. A wave washer 329 is positioned above the base 324 and around a lower portion of the intermediate portion 326. The base 324 is removably connected to a mounting stud 327 of an engine. For example, the adapter 320 may be configured to be snapably, threadably, latchably, or otherwise removably secured to the mounting stud 327.

The intermediate portion 326 includes a plurality of locking cylinders 330, which may be spring-biased The cylinders 330 extend outwardly from the intermediate portion 326 at an angle. For example, the cylinders 330 may be oriented at a 45 degree angle with respect to an axis of the adapter 320, such as shown in FIG. 18. Optionally, the cylinders 330 may be oriented at other angles, and may even by horizontally or vertically disposed, depending upon the nature of the features of the filter module (not shown in FIG. 18) that are configured to engage the cylinders 330. Pressure exerted by internal components (not shown in FIG. 18) operatively connected to the cylinders 330 keeps the cylinders 330 in a fully extended position (as shown in FIG. 18). As discussed below, however, when force is exerted on the cylinders 330 by a filter module (discussed below), the cylinders 330 are urged further into the intermediate portion 326.

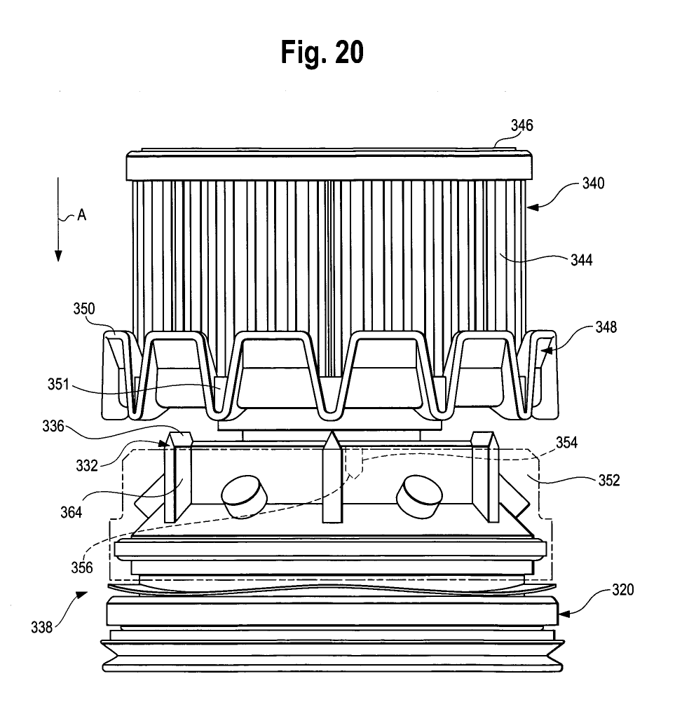

A plurality of splines 332 are positioned circumferentially around the intermediate portion 326. Each spline 332 includes an extending member 334 terminating in a beveled tip 336. As discussed below with respect to FIG. 20, the splines 332 may be used in conjunction with features on the filter module to ensure that the adapter 320 is secured to the mounting stud of the engine.

FIG. 19 illustrates a front view of an oil filter assembly 338 according to an embodiment of the present invention. The oil filter assembly 338 includes a filter module 340 having an outer housing 342 and the adapter 320. As shown in FIG. 19, the filter module 340 is secured to the adapter 320.

Once the filter module 340 is securely connected to the adapter 320, unfiltered oil from an engine may pass from oil inlet openings formed through the adapter 320 into oil inlet passages of the filter module 340. The unfiltered oil then passes through a filter chamber of the filter module 340, wherein the unfiltered oil is passed through a filtering medium, which filters impurities from the oil. The filtered oil passes through an oil outlet of the filter module 340 into the adapter 320. The filtered oil then passes through the adapter 320 back into the engine.

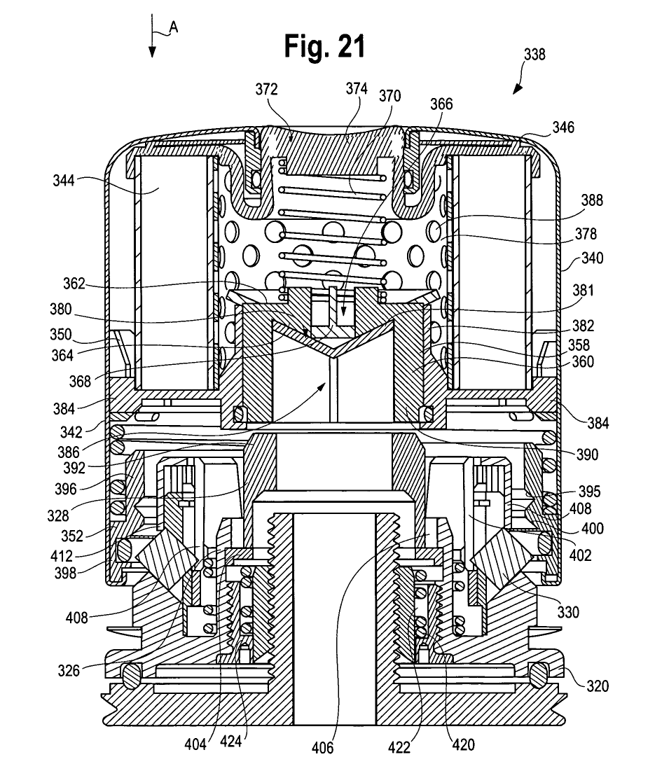

FIG. 20 illustrates a partial internal view of the oil filter assembly 338 with particular components, such as the outer housing 342 (shown in FIG. 19) hidden. The filter module 340 includes a filter medium 344 supported between a top cap 346 and an end cap (shown, for example, as end cap 384 in FIG. 21) A seal member 348 including a plurality of flaps 350 that extends over a portion of the filter medium 344. Beams 351, which extend from an inner anti-spill valve (discussed below) are positioned between the flaps 350 and abut, and/or are integrally connected to, an inner wall (not shown) of the filter module 340. The seal member 348 is positioned proximate an oil inlet of the filter module.

When oil enters the filter module 340, the pressure of the incoming oil moves the flaps 350 toward the filter medium 344, thereby allowing the incoming oil to pass into the filter medium 340. When oil is not circulating through the filter assembly 338, the flaps 350 return to the original position against an inner wall (not shown) of the filter module 320 thereby forming a sealing interface.

The filter module 340 also includes a bottom plate 352, which is transparent in FIG. 20. The bottom plate 352 includes tabs 354 having beveled tips 356. As the filter module 340 is mated to the adapter 320 in the direction of arrow A, the beveled tips 356 of the tabs 354 slide past the tips 336 of the splines 332. Once the filter module 340 is mated onto the adapter 320, the oil filter assembly 338 may be used as a tool to secure the adapter 320 to a mounting stud of an engine.

For example, the adapter 320, but not the filter module 340, may be configured to threadably engage the mounting stud. The oil filter assembly 338 may be used to thread the adapter 320 onto the mounting stud. Once the adapter 320 is threadably secured to the mounting stud, the adapter 320 will no longer be able to be rotated in a securing direction in relation to the mounting stud. At this point, the filter module 340 may be able to be rotated until the tabs 354 are rotated into an adjacent spline 332. The engagement between the tabs 354 and splines 332 precludes further rotation of the filter module 340 with respect to the adapter 320, thereby alerting the user that the adapter 320 is secured to the mounting stud. Once the adapter 320 is secured to the mounting stud, the adapter 320 remains on the stud, and the filter module 340 may be removed from the adapter 320 by pressing a button on the filter module 340, as described below. The filter module 340 may be able to be rotated in a direction opposite the securing direction relative to the adapter 320 until it engages a tab 354 encounters an adjacent spline 332. Further rotation in this direction then exerts a corresponding force into the adapter 320 with respect to the mounting stud, in order to threadably disengage the adapter 320 from the mounting stud. Optionally, once the adapter 320 is secured to the mounting stud, the adapter 320 and the filter module 340 may be precluded from further rotation in a securing direction.

FIG. 21 illustrates a cross-sectional view of the oil filter assembly 338 in which the filter module 340 is disconnected from the adapter 320. The filter module 340 includes a drip seal plug 358 having lateral posts 360 integrally formed with upper walls 362 having angled lower surfaces 364. The filter module 340 may include two, three, four, or any number of posts 360. A gap 366 is formed between the upper walls 362 and a bridging member 368 is positioned within the gap 366. The bridging member 368 may be integrally formed with the drip seal plug 358.

A spring 370 is positioned between the upper walls 362 of the drip seal plug 358 and an actuator 372. As shown in FIG. 21, the actuator 372 includes a button portion 374 positioned over the spring 370. The button portion 374 is integrally formed with the top cap 346 that is positioned over the filter medium 344 and a filtered fluid passage tube 378.

In the disconnected position, an anti-spill valve 380 sealingly engages the drip seal plug 358 when the filter module 340 is disconnected from the adapter 320. The valve 380 may be formed of molded plastic, rubber, or other such materials that prevent fluid from passing therethrough. The valve 380 includes an angled sealing member 381 that sealingly engages the lower surfaces 364 of the drip seal plug 358. The angled sealing member 381 is integrally formed with a lateral wall 382, which is in turn integrally formed with an end cap 384 that is secured to an inner wall of the outer housing 342. As shown above with respect to FIG. 20, the beams 351 extend outwardly from the end cap 384.

In the disconnected position, the drip seal plug 358 prevents fluid from passing into a fluid passage 386 defined by the lateral walls 382 of the valve 380. As shown in FIG. 21, fluid passage from the fluid openings 388 of the fluid passage tube 378 into the fluid passage 386 is blocked by way of the sealing engagement between the sealing member 381 and the lower surfaces 364 of the drip seal plug 358. In order to secure the filter module 340 to the adapter 320 and allow fluid to flow into the fluid passage 386, the filter module 340 is urged into the adapter 320 in the direction of arrow A.

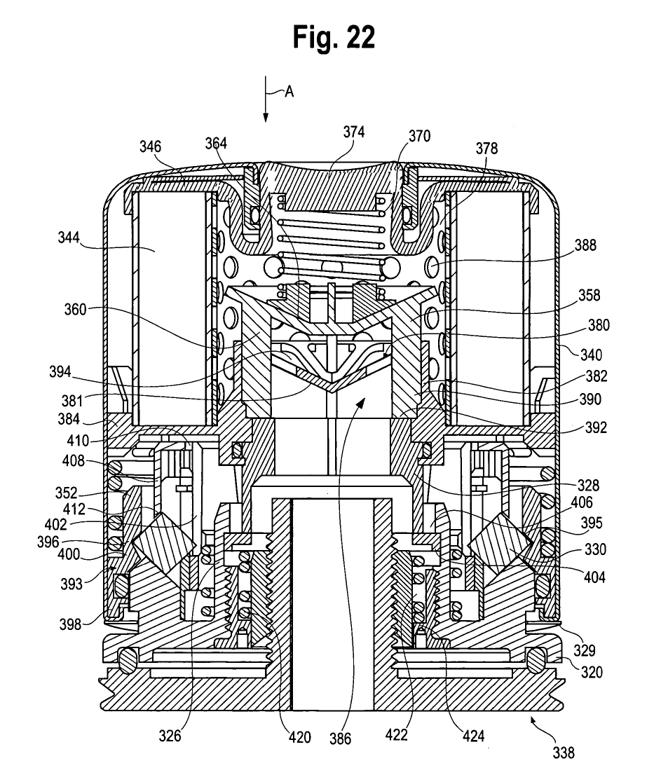

FIG. 22 illustrates a cross-sectional view of the oil filter assembly 338 in which the filter module 340 is connected to the adapter 320. Referring to FIGS. 21 and 22, when the filter module 340 is urged into the adapter 320, the distal ends 390 of the lateral posts 360 engage upper surfaces 392 of the central tube 328 of the adapter 320. Thus, the drip seal plug 358 is impeded from moving further into the adapter 320.

As the filter module 340 continues to be urged in the direction of arrow A, the remainder of the filter module 340 moves toward the adapter 320, while the spring 370 compresses between the button portion 374 and the drip seal plug 358. The sealing member 381 separates from the lower surfaces 364 of the drip seal plug 358. As such, fluid may pass from the openings 388 of the fluid passage tube 378 into the fluid passage 386 through the openings 394 formed in the sealing member 381. When the filter module 340 is disconnected from the adapter 320, the openings 394 are closed by the lower surfaces 364 of the drip seal plug 358.

At the same time the sealing member 381 disengages from the drip seal plug 358, the bottom plate 352 engages the cylinders 330. The bottom plate 352 includes an upper portion 396 integrally formed with a wider lower portion 398 through a slanted intermediate portion 400. A groove 395 is formed in the upper portion 396. As the bottom plate 352 moves toward the adapter 320, the slanted intermediate portion 400 slides over the cylinder 330, thereby urging the cylinder 330 downward and into the adapter 320. The movement of the cylinder 330 pushes an inner trigger sleeve 402, which exerts a constant spring force into the cylinder 330, toward the center of the adapter 320. The bottom plate 352 continues to slide over the cylinder 330 until the cylinder 330 snapably secures into the groove 395, thereby securely connecting the filter module 340 to the adapter 320.

A pressure relief valve 404 is disposed at an end of a relief passage 406 defined between the intermediate portion 326 and the center tube 328 of the adapter 320. A spring 420 is positioned within a channel 422 between the pressure relief valve 404 and a base 424 of the channel 422. The spring 420 exerts a force into the relief valve 404, thereby maintaining the relief valve 404 in a closed position. The spring 420, only exerts enough force to keep the relief valve 404 closed up to a certain point. When a fluid differential pressure on the relief valve 404 (i.e., a difference between a fluid pressure on one side of the valve 404 and a fluid pressure on the other side of the valve 404) becomes too high, the spring 420 compresses, thereby allowing the relief valve 404 to open. Various springs having different force constants may be used, depending upon the desired point at which the relief valve 404 is to open.

In order to disconnect the filter module 340 from the adapter 320, the button portion 374 is pressed in the direction of arrow A. As the button portion 374 is pressed, the integrally connected top cap 346 exerts a force into the filter medium 344 and the fluid passage tube 378 in the direction of arrow A. These components, in turn, exert a force into the bottom end cap 384, which in turn exerts a force into the inner trigger sleeve 402 and an outer trigger sleeve 408. The inner trigger sleeve 402 and outer trigger sleeve 408 may be separated by a gap 410. As force is exerted into the trigger sleeves 402 and 408 in the direction of arrow A, a slanted distal end 412 of the outer trigger sleeve 408 engages the cylinder 330, pushing the cylinder 330 downward and toward the central axis of the adapter 320, thereby removing the cylinder 330 from the groove 395.

Once the cylinders 330 are removed from, or otherwise disengage, the grooves 395, the filter module 340 no longer securely engages the adapter 320. The wave washer 329 exerts a force into the filter module 340, thereby pushing the filter module 340 away from the adapter 320.

As the filter module 340 disengages from the adapter 320, the inner sleeve 402 pushes the cylinder 330 back into its fully-extended position. Simultaneously, the pressure exerted by the compressed spring 370 urges the drip seal plug 358 back toward the sealing member 381 as the drip seal plug 358 disengages from the center tube 328.

While the oil filter assembly 338 is shown with a plurality of cylinders 330, more or less than the cylinders 330 shown may be utilized. Further, instead of a plurality of cylinders 330, a resilient ring positioned around the intermediate portion 326 may be used. Additionally, the cylinders 330, bottom plate 352, sleeves 402, 408 and other components designed to securely connect the filter module 340 to the adapter 320 may be used with the other embodiments discussed above. Similarly, the sealing interfaces shown and described with respect to other embodiments may be used with the oil filter assembly 338, and vice versa.

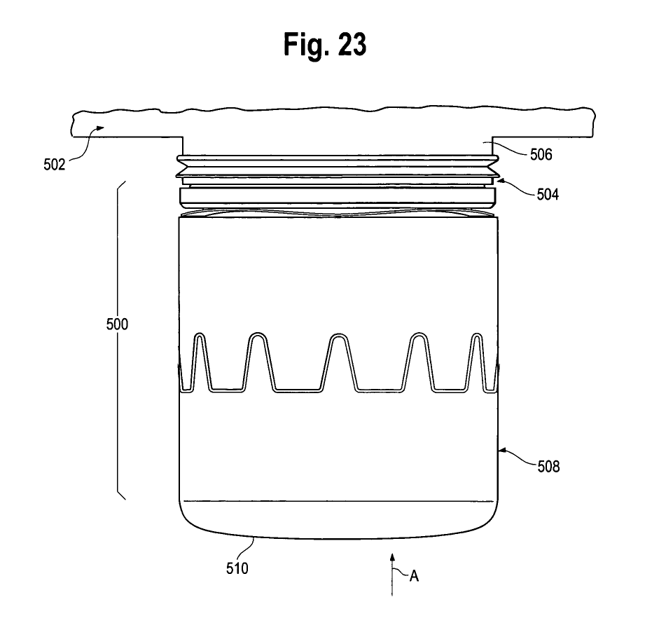

FIG. 23 illustrates a front view of an oil filter assembly 500 secured to an engine 502, according to an embodiment of the present invention. The oil filter assembly 500 may be any of the oil filter assemblies discussed with respect to FIGS. 1-22. The oil filter assembly 500 includes an adapter 504, which may be threadaby, snapably, latchably, or otherwise secured to a mounting stud 506 of the engine 502. Optionally, the adapter 504 may be integrally formed with the mounting stud 506.

A filter module 508 is simply urged into the adapter 504 in the direction of arrow A in order to connect the filter module 508 to the adapter 504. The filter module 508 is not screwed, or otherwise rotated, with respect to the adapter 504 in order to securely connect the filter module 508 to, or disconnect it from, the adapter 504. In order to disconnect the filter module 508 from the adapter 504, a button located at a proximal end 510 of the filter module 508 is pressed, thereby releasing the filter module 508 from the adapter 504.

Thus, embodiments of the present invention provide an oil filter assembly that is quick and easy to connect and disconnect from an engine. In general, embodiments of the present invention provide a system and method of quickly and efficiently changing an oil filter. The oil filter module may be removed from the adapter by merely pressing a button disposed on the oil filter module. Once the old filter module, or insert, is removed, a new one may be connected to the adapter. Optionally, the oil filter module may be removed and the filter medium within the insert replaced. Then, the insert containing the new filter medium may be connected to the adapter.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. A fluid filter system comprising:
a first segment having a ridge adapted to engage a detent; and
a second segment having
a medium for filtering said fluid;
a detent engageable with said ridge to secure said first segment to said second segment, said detent being moveable between a locked position and an unlocked position, and being normally biased into said locked position; and
an actuator for selectively urging said detent into said unlocked position, thereby releasing said second segment from said first segment.

2. The fluid filter system of claim 1, wherein said actuator is located on a user accessible side of said fluid filter system, and said first segment is located on an engine side of said fluid filter system.

3. The fluid filter system of claim 1, wherein said detent comprises at least one locking collar.

4. The fluid filter system of claim 1, further comprising a resilient ring positioned around said detent, said resilient ring exerting a force into said detent.

5. The fluid filter system of claim 1, said detent having an actuator engagement recess, said actuator being urged into said actuator engagement recess thereby disengaging said detent from said ridge.

6. The fluid filter system of claim 1, wherein said detent snapably engages said ridge.

7. The fluid filter system of claim 1, wherein said second segment further comprises:
a filter support having an end cap and a perforated tube;
a central tube disposed within said perforated tube, said central tube defining an actuator channel therein, wherein said actuator and said detent are disposed within said actuator channel;
a fluid outlet channel defined between said perforated tube and said central tube;
said medium being disposed around said perforated tube and supported by said end cap.

8. The fluid system of claim 7, further comprising a filter enclosure disposed over said medium.

9. The fluid filter system of claim 8, further comprising a housing disposed over said filter enclosure, wherein a portion of said first segment is compressively sandwiched between a portion of said housing and a portion of said filter enclosure when said second segment is connected to said first segment.

10. The fluid filter system of claim 9, further comprising a seal disposed between said portion of said filter enclosure and said portion of said first segment.

11. The fluid filter system of claim 1, wherein said first segment further comprises an unfiltered fluid opening and a filtered fluid passage; and wherein said second segment comprises an unfiltered fluid inlet passage in communication with said unfiltered fluid opening and a filtered fluid outlet channel in communication with said filtered fluid passage when said second segment is connected to said first segment.

12. The fluid filter system of claim 11, further comprising a fluid inlet valve disposed within said unfiltered fluid inlet passage, wherein said fluid inlet valve opens when fluid circulates through the fluid filter system.

13. The fluid filter system of claim 11, further comprising a fluid outlet valve disposed proximate an outlet of said filtered fluid outlet channel, wherein said fluid outlet valve opens when fluid circulates through the fluid filter system.

14. The fluid filter system of claim 1, wherein said second segment is urged in a linear direction into said first segment to connect said second segment to said first segment.

15. The fluid filter system of claim 1, wherein said actuator comprises a head integrally formed with a shaft having a detent engaging end, said head being contacted to urge said detent engaging end into to said detent.

16. The fluid filter system of claim 15, wherein said detent engaging end comprises outwardly extending tabs that are configured to be urged into said detent and disengage said detent from said ridge.

17. The fluid filter system of claim 15, further comprising a button cover positioned proximate said head, wherein said button cover protects said head from unintended engagement.

18. The fluid filter system of claim 17, wherein said button cover is configured to be pushed into said head.

19. The fluid filter system of claim 1, wherein said first segment is configured to be screwed onto an engine.

20. The fluid filter system of claim 1, wherein said first segment is integrally formed with an engine.

21. The fluid filter system of claim 1, further comprising a spring secured to said first segment, wherein said spring abuts said second segment and exerts a force into said second segment when said second segment is connected to said first segment, and wherein said spring acts to push said second segment away from said first segment when said detent disengages said ridge.

22. The fluid filter system of claim 1, wherein said second segment is used to secure said first segment to an engine.

23. The fluid filter system of claim 22, wherein said second segment and said first segment are configured to rotate along with one another when said first segment is being connected to the engine, and wherein said first and second segments are not allowed to rotate along with one another when said first segment is secured to the engine.

24. The fluid filter system of claim 23, wherein said first segment no longer rotates when said first segment is secured to the engine.

25. The fluid filter system of claim 24, wherein rotation of said second segment relative to said first segment produces a clicking sound.

26. An oil filter system configured to filter oil used within an engine, the system comprising:
an oil filter module having a detent and an actuator; and
an, adapter configured to be secured to the engine, said adapter having a protuberance, said oil filter module connecting to said adapter when said detent secures to said protuberance as said oil filter module is urged into a connection position with said adapter, and said oil filter module disconnecting from said adapter when said actuator is actuated, thereby disengaging said detent from said protuberance.

27. The oil filter system of claim 26, further comprising a resilient ring positioned around said detent, said resilient ring exerting a force into detent.

28. The oil filter system of claim 26, said detent comprising at least one lock defining an actuator engagement recess, said actuator being urged into said actuator engagement recess thereby spreading said at least one lock open, and said at least one lock disengaging from said protuberance when said at least one lock is spread open.

29. The oil filter system of claim 26, wherein said detent snapably engages said protuberance.

30. The oil filter system of claim 26, wherein said oil filter module further comprises:
a filter support having an end cap and a perforated tube;
a central tube disposed within said perforated tube, said central tube defining an actuator channel therein, wherein said actuator and said detent are disposed within said actuator channel;
an oil outlet channel defined between said perforated tube and said central tube; and
a filter medium disposed around said perforated tube and supported by said end cap.

31. The oil filter system of claim 30, further comprising a filter enclosure disposed over said filter medium.

32. The oil filter system of claim 31, further comprising a housing disposed over said filter enclosure, wherein a portion of said adapter is compressively sandwiched between a portion of said housing and a portion of said filter enclosure when said filter module is connected to said adapter.

33. The oil filter system of claim 32, further comprising a seal disposed between said portion of said filter enclosure and said portion of said adapter.

34. The oil filter system of claim 26, wherein said adapter further comprises an unfiltered oil opening and a filtered oil passage; and wherein said filter module comprises an unfiltered oil inlet passage in communication with said unfiltered oil opening and a filtered oil outlet channel in communication with said filtered oil passage when said filter module is connected to said adapter.

35. The oil filter system of claim 34, further comprising an oil inlet valve disposed within said unfiltered oil inlet passage, wherein said oil inlet valve opens when oil circulates through the oil filter system.

36. The oil filter system of claim 34, further comprising an oil outlet valve disposed proximate an outlet of said filtered oil outlet channel, wherein said oil outlet valve opens when oil circulates through the oil filter system.

37. The oil filter system of claim 26, wherein said filter module is urged in a linear direction into said adapter to connect said filter module to said adapter.

38. The oil filter system of claim 26, wherein said actuator comprises a head integrally formed with a shaft having a detent engaging end, said head being contacted to urge said detent engaging end into to said detent in order to disengage said detent from said protuberance.

39. The oil filter system of claim 38, wherein said detent engaging end comprises outwardly extending tabs that are configured to be urged into said at detent.

40. The oil filter system of claim 38, further comprising a button cover positioned proximate said head, wherein said button cover protects said head from unintended engagement.

41. The oil filter system of claim 40, wherein said button cover is configured to be pushed into said head.

42. The oil filter system of claim 26, wherein said adapter is configured to be screwed onto the engine.

43. The oil filter system of claim 26, wherein said adapter is integrally formed with the engine.

44. The oil filter system of claim 26, further comprising a spring secured to said adapter, wherein said spring abuts said filter module and exerts a force into said filter module when said filter module is connected to said adapter, and wherein said spring acts to push said filter module away from said adapter when said at least one lock disengages said protuberance.

45. The oil filter system of claim 26, wherein said protuberance comprises:
a shaft having a notch formed therein; and
a beveled tip, wherein said notch is configured to snapably retain a portion of said detent.

46. The oil filter system of claim 26, wherein said oil filter module is used to secure said adapter to the engine.

47. The oil filter system of claim 46, wherein said oil filter module and said adapter are configured to rotate along with one another when said adapter is being secured to the engine, and wherein said adapter and said oil filter module do not rotate along with one another when said adapter is secured to the engine.

48. The oil filter system of claim 47, wherein said adapter no longer rotates when said adapter is secured to the engine.

49. The oil filter system of claim 48, wherein rotation of said oil filter module relative to said first segment produces a click.

50. The oil filter system of claim 26, wherein said detent is a latch tube having a fluid passage defined therethrough, and wherein said protuberance is at least one retaining member configured to engage said detent.

51. The oil filter system of claim 50, wherein said at least one retaining member is a ball.

52. The oil filter system of claim 26, wherein said oil filter module further comprises a spring biased plug seal, and wherein said plug seal sealingly closes a fluid outlet of said oil filter module when said oil filter module is disconnected from said adapter.

53. The oil filter system of claim 26, wherein said oil filter module further comprises a bottom plate, said bottom plate comprising a groove, wherein said detent is said groove.

54. The oil filter system of claim 53, wherein said adapter further comprises a main body having a cylinder extending outwardly therefrom, wherein said protuberance is said cylinder.

55. The oil filter system of claim 54, wherein said cylinder extends outwardly from said main body at an angle.

56. The oil filter system of claim 26, wherein said adapter further comprises a spline; and said oil filter module further comprises a tab that is configured to align with said spline when said oil filter module is connected to said adapter, wherein said oil filter system is configured to be used as a tool to secure said adapter to the engine, and wherein said adapter is secured to the engine when said tab is rotated into an engagement position with said tab.

57. The oil filter system of claim 26, wherein said oil filter module further comprises a seal member having a plurality of flaps, wherein said flaps are configured to cover an oil inlet of said filter module when oil is not passing through said oil filter system, and wherein said flaps are configured to move away from the oil inlet when oil passes through said oil filter system.

58. The oil filter system of claim 26, wherein said actuator comprises a button portion integrally connected to a top cap, wherein a cross-sectional area of said actuator is substantially equal to a cross-sectional area of said oil filter module.

59. The oil filter system of claim 26, wherein said oil filter module further comprises a drip seal plug and an anti-spill valve, wherein said anti-spill valve sealingly engages said drip seal plug when said oil filter module is disconnected from said adapter, and wherein said anti-spill valve disengages from said drip seal plug when said oil filter module connects to said adapter.

60. The oil filter system of claim 26, wherein said adapter further comprises a spring-biased pressure relief valve.

61. An oil filter module configured to be removably connected to an adapter secured to an engine, wherein the adapter includes an outwardly extending member, the oil filter module comprising:
a filter support having an end cap and a perforated tube;
a central tube disposed within said perforated tube, said central tube defining a plunger channel therein;
an oil outlet channel defined between said perforated tube and said central tube;
a filter medium disposed around said perforated tube and supported by said end cap; and
a plunger and at least one lock disposed within said plunger channel, said plunger being configured to be actuated within said plunger toward said at least one lock, said oil filter module being configured to connect to the adapter when said at least one lock securably engages the outwardly extending member when said oil filter module is urged into connection with the adapter, and said oil filter module disconnecting from the adapter when said plunger is actuated into said at least one lock, thereby disengaging said at least one lock from said outwardly extending member.

62. The oil filter module of claim 61, further comprising a resilient ring positioned around said at least one lock, said resilient ring exerting a compressive force into said at least one lock.

63. The oil filter module of claim 61, said at least one lock defining a plunger engagement recess, said plunger being urged into said plunger engagement recess thereby spreading said at least one lock open, and said at least one lock disengaging from said outwardly extending member when said at least one lock is spread open.

64. The oil filter module of claim 61, wherein said at least one lock snapably engages around said spike.

65. The oil filter module of claim 61, further comprising a filter enclosure disposed over said filter medium.

66. The oil filter module of claim 65, further comprising a housing disposed over said filter enclosure, wherein a portion of the adapter is configured to be compressively sandwiched between a portion of said housing and a portion of said filter enclosure when said filter module is connected to said adapter.

67. The oil filter module of claim 61, further comprising an unfiltered oil inlet passage and a filtered oil outlet channel.

68. The oil filter module of claim 67, further comprising an oil inlet valve disposed within said unfiltered oil inlet passage, wherein said oil inlet valve opens when oil circulates through the oil filter module.

69. The oil filter module of claim 67, further comprising an oil outlet valve disposed proximate an outlet of said filtered oil outlet channel, wherein said oil outlet valve opens when oil circulates through the oil filter module.

70. The oil filter module of claim 61, wherein the filter module is urged in a linear direction into the adapter to connect the filter module to the adapter.

71. The oil filter module of claim 61, wherein said plunger comprises a head integrally formed with a shaft having a lock engaging end, said head being contacted to urge said lock engaging end into to said at least one lock.

72. The oil filter module of claim 71, wherein said lock engaging end comprises outwardly extending tabs that are configured to be urged into said at least one lock and spread said at least one lock open.

73. The oil filter system of claim 71, further comprising a button cover positioned proximate said head, wherein said button cover protects said head from unintended engagement.

74. The oil filter module of claim 61, wherein said button cover is configured to be pushed into said head.

75. An oil filter adapter configured to be secured to a mounting structure of an engine, the adapter also configured to retain a removable filter module, the adapter comprising:
a main body having at least one oil inlet opening and at least one oil outlet opening formed through said main body, said at least one oil inlet opening allowing unfiltered oil to pass from the engine to the filter module, said at least one oil outlet opening allowing filtered oil to pass from the filter module to the engine; and
an insert securing member, said insert securing member being configured to securely retain a portion of the filter module in order to connect the filter module to the adapter, wherein said insert securing member allows the filter module to be secured to, and removed from, the adapter without the filter module being rotated.

76. The adapter of claim 75, wherein said insert securing member is one of a spike, ridge, post and barb.

77. The adapter of claim 75, wherein said insert securing member is a ball positioned about a portion of a circumference of a tube defining said oil outlet opening.

78. The adapter of claim 75, wherein said insert securing member comprises:
a shaft having a notch formed therein; and
a beveled tip, wherein said notch is configured to snapably retain the portion of the filter module.

79. The adapter of claim 75, wherein said main body further comprises at least one bypass opening.

80. The adapter of claim 75, wherein said main body is configured to threadably engage the mounting structure of the engine.

81. The adapter of claim of claim 75, wherein said main body is integrally formed with the engine.

82. The adapter of claim 75, wherein said insert securing member outwardly extends from a center of said main body.

83. The adapter of claim 75, further comprising a wave washer configured to exert a force into the filter module when the filter module is connected to the adapter.

84. The adapter of claim 75, wherein said insert securing member is at least one cylinder outwardly extending from said main body.

85. The adapter of claim 84, wherein said at least one cylinder extends outwardly from said main body at an angle.

86. The adapter of claim 75, further comprising at least one spline extending from said main body, wherein said at least one spline is configured to cooperate with a component of the filter module to indicate that the adapter is securely fastened to the mounting structure of the engine.

87. A method of disconnecting an oil filter module from an oil filter adapter, wherein the oil filter module includes a detent secured to a protuberance of the adapter, the method comprising:
pushing a button disposed on the oil filter module;
disengaging the detent from the protuberance through said pushing; and
disconnecting the oil filter module from the oil filter adapter through said disengaging.

88. The method of claim 87, wherein said pushing comprises actuating a plunger toward the detent through said pushing, wherein said actuating causes said disengaging.

89. The method of claim 87, wherein said pushing comprises actuating an end cap of the oil filter module into a trigger sleeve of the adapter, wherein said actuating causes the trigger sleeve to move the protuberance away from the detent.

90. The method of claim 87, wherein said pushing comprises pushing a button cover disposed over a plunger head, said pushing a button cover comprising pushing said button cover into the plunger head.

91. The method of claim 88, wherein said disengaging comprises spreading the detent open through said actuating, wherein said spreading comprises removing the detent from a retaining feature of the protuberance.

92. The method of claim 87, wherein said disconnecting comprises forcing the oil filter module away from the oil filter adapter through a spring.

93. The method of claim 87, wherein said disconnecting comprises removing the oil filter module from the oil filter adapter in a linear, non-twisting direction.

94. An oil filter system configured to filter oil used within an engine, the system comprising:
an oil filter module comprising:
at least one lock defining a plunger engagement recess;
a resilient ring positioned around said at least one lock, said resilient ring exerting a force into said at least one lock; and
a plunger configured to be actuated toward said at least one lock, said plunger being urged into said plunger engagement recess thereby spreading said at least one lock open, and said at least one lock disengaging from said spike when said at least one lock is spread open;
a filter support having an end cap and a perforated tube;
a central tube disposed within said perforated tube, said central tube defining a plunger channel therein, wherein said plunger and said at least one lock are disposed within said plunger channel;
an oil outlet channel defined between said perforated tube and said central tube; and
a filter medium disposed around said perforated tube and supported by said end cap; and
an adapter configured to be secured to the engine, said adapter having a spike extending outwardly therefrom, said oil filter module connecting to said adapter when said at least one lock snapably secures to said spike as said oil filter module is urged into a connection position with said adapter, and said oil filter module disconnecting from said adapter when said plunger is actuated into said at least one lock, thereby disengaging said at least one lock from said spike.

95. The oil filter system of claim 94, further comprising a filter enclosure disposed over said filter medium.

96. The oil filter system of claim 95, further comprising a housing disposed over said filter enclosure, wherein a portion of said adapter is compressively sandwiched between a portion of said housing and a portion of said filter enclosure when said filter module is connected to said adapter.

97. The oil filter system of claim 96, further comprising a seal disposed between said portion of said filter enclosure and said portion of said adapter.

98. The oil filter system of claim 94, wherein said adapter further comprises an unfiltered oil opening and a filtered oil passage; and wherein said filter module comprises an unfiltered oil inlet passage in communication with said unfiltered oil opening and a filtered oil outlet channel in communication with said filtered oil passage when said filter module is connected to said adapter.

99. The oil filter system of claim 98, further comprising an oil inlet valve disposed within said unfiltered oil inlet passage, wherein said oil inlet valve opens when oil circulates through the oil filter system.

100. The oil filter system of claim 98, further comprising an oil outlet valve disposed proximate an outlet of said filtered oil outlet channel, wherein said oil outlet valve opens when oil circulates through the oil filter system.

101. The oil filter system of claim 94, wherein said plunger comprises a head integrally formed with a shaft having a lock engaging end, said head being contacted to urge said lock engaging end into to said at least one lock.

102. The oil filter system of claim 101, wherein said lock engaging end comprises outwardly extending tabs that are configured to be urged into said at least one lock and spread said at least one lock open.

103. The oil filter system of claim 101, further comprising a button cover positioned proximate said head, wherein said button cover protects said head from unintended engagement.

104. The oil filter system of claim 94, further comprising a spring secured to said adapter, wherein said spring abuts said filter module and exerts a force into said filter module when said filter module is connected to said adapter, and wherein said spring acts to push said filter module away from said adapter when said at least one lock disengages said spike.

105. The oil filter system of claim 94, wherein said spike comprises:
a shaft having a notch formed therein; and
a beveled tip, wherein said notch is configured to snapably retain a portion of said at least one lock.

106. A fluid filter system comprising:
a filter module including a button and a latching tube having a retaining slot formed about an inner circumference, wherein a fluid passage is formed through a central portion of said latching tube; and
an adapter having at least one retaining member positioned about an outer periphery of a sleeve having a fluid channel formed therethrough, said retaining slot being configured to receive and retain said at least one retaining member, said filter module connecting to said adapter when said retaining slot receives and retains said retaining member as said filter module is urged into a connection position with said adapter, and said filter module disconnecting from said adapter when said button is pressed, thereby disengaging said retaining member from said retaining slot.

107. The system of claim 106, wherein said filter module further comprises an actuator operatively connected to said button and said latching tube, said actuator urging said sleeve toward into said adapter causing said retaining member to disengage from said retaining slot when said button is pressed.

108. The system of claim 106, further comprising a collar member, wherein said sleeve comprises a first portion integrally formed with a second portion through a slanted ledge, said first portion having a smaller diameter than said second portion, and wherein said retaining member is compressively sandwiched between said collar member and said upper portion when said filter module is disconnected from said adapter.

109. The system of claim 108, wherein said latching tube urges said collar member into a position in which said collar member disengages from said retaining member when said insert module is urged into said connection position, and wherein said latching tube engages said retaining member when said collar member disengages from said retaining member.

110. The system of claim 106, further comprising a spring-biased plug seal that automatically plugs a fluid outlet of said filter module when said filter module is disconnected from said adapter.

111. The system of claim 110, wherein said sleeve further comprises a central post, wherein said central post engages a reciprocal structure on said plug seal when said filter module is urged into said adapter, said central post exerting a force into said reciprocal structure thereby urging said plug seal into an open position such that fluid may pass through said fluid outlet of said filter module.

112. The system of claim 106, wherein said at least one retaining member is a ball.

113. The system of claim 106, wherein said filter module is urged in a linear direction into said adapter to connect said filter module to said adapter.

114. A fluid filter system comprising:
a filter module including a disconnect button; and
an adapter that is removably secured to said filter module, wherein said filter module disconnects from said adapter when said disconnect button is pressed.

115. The fluid filter system of claim 114, wherein said filter module is urged in a linear direction into said adapter to connect said filter module to said adapter.

116. The fluid filter system of claim 114, wherein said filter module is removed from said adapter in a linear direction.

117. The fluid filter system of claim 114, wherein said disconnect button is distally located from said adapter when said filter module is connected to said adapter.

118. The fluid filter system of claim 114, wherein said disconnect button is an end of said filter module.

119. A fluid filter system configured to filter fluid of a device, said system comprising:
a filter module comprising a main body having a securing plate and an actuator, wherein a detent is formed in said securing plate; and
an adapter configured to be secured to the device, said adapter having a main body with at least one spring-biased protuberance extending outwardly therefrom, said filter module connecting to said adapter when said detent secures to said protuberance as said filter module is urged into a connection position with said adapter, and said filter module disconnecting from said adapter when said actuator is actuated, thereby disengaging said detent from said protuberance.

120. The system of claim 119, wherein said detent is at least one of a groove, notch, and channel.

121. The system of claim 119, wherein said protuberance is a cylinder.

122. The system of claim 121, wherein said cylinder extends outwardly from said main body at an angle.

123. The system of claim 119, wherein said adapter further comprises a spline; and said filter module further comprises a tab that is configured to align with said spline when said filter module is connected to said adapter, wherein said filter system is configured to be used as a tool to secure said adapter to the device, and wherein said adapter is securely fastened to the device when said tab is rotated into an engagement position with said tab.

124. The system of claim 119, wherein said filter module further comprises a seal member having a plurality of flaps, wherein said flaps are configured to cover a fluid inlet of said filter module when fluid is not passing through said filter system, and wherein said flaps are configured to move away from the fluid inlet when fluid passes through said filter system.

125. The system of claim 119, wherein said actuator comprises a button portion integrally connected to a top cap, wherein a cross-sectional area of said actuator is substantially equal to a cross-sectional area of said oil filter module.

126. The system of claim 119, wherein said filter module further comprises a drip seal plug and an anti-spill valve, wherein said anti-spill valve sealingly engages said drip seal plug when said filter module is disconnected from said adapter, and wherein said anti-spill valve disengages from said drip seal plug when said filter module connects to said adapter.

127. The system of claim 119, wherein said adapter further comprises a spring-biased pressure relief valve.

128. The system of claim 119, wherein said filter module is urged in a linear direction into said adapter to connect said filter module to said adapter.

129. The system of claim 119, wherein said filter module is removed from said filter module in a linear direction.
